(19) United States
(12) Patent Application Publication
(10) Pub. No.: US 2025/0021848 A1
(43) Pub. Date: Jan. 16, 2025

(54) INFORMATION PROCESSING METHOD, INFORMATION PROCESSING APPARATUS, AND PROGRAM

(71) Applicant: FUJIFILM Corporation, Tokyo (JP)

(72) Inventors: Masahiro SATO, Tokyo (JP); Tomoki TANIGUCHI, Tokyo (JP); Tomoko OHKUMA, Tokyo (JP)

(73) Assignee: FUJIFILM Corporation, Tokyo (JP)

(21) Appl. No.: 18/896,911

(22) Filed: Sep. 26, 2024

Related U.S. Application Data
(63) Continuation of application No. PCT/JP2023/010628, filed on Mar. 17, 2023.

(30) Foreign Application Priority Data
Mar. 28, 2022 (JP) 2022-051709

(51) Int. Cl. G06N 7/01

(52) U.S. Cl. CPC G06N 7/01

(57) ABSTRACT

Provided are an information processing method, an information processing apparatus, and a program capable of generating data of a user behavior history of different domains. An information processing method executed by one or more processors, the method includes: causing the one or more processors to represent a simultaneous probability distribution between a response variable and an explanatory variable, with a behavior for an item of an user as the response variable, for a dataset including a behavior history with respect to a plurality of the items of a plurality of the users, modify a part of the simultaneous probability distribution, and generate data based on the modified simultaneous probability distribution.

### CROSS-REFERENCE TO RELATED APPLICATIONS

The present application is a Continuation of PCT International Application No. PCT/JP2023/010628 filed on Mar. 17, 2023 claiming priority under 35 U.S.C § 119 (a) to Japanese Patent Application No. 2022-051709 filed on Mar. 28, 2022. Each of the above applications is hereby expressly incorporated by reference, in its entirety, into the present application.

### BACKGROUND OF THE INVENTION

### 1. Field of the Invention

The present disclosure relates to an information processing method, an information processing apparatus, and a program, and more particularly, to an information processing technique of generating data of different domains.

### 2. Description of the Related Art

In a system that provides various items to a user, such as an electronic commerce (EC) site or a document information management system, it is difficult for the user to select the best item that suits the user from among many items in terms of time and cognitive ability. The item in the EC site is a product handled in the EC site, and the item in the document information management system is document information stored in the system.

In order to assist the user in selecting an item, an information suggestion technique, which is a technique of presenting a selection candidate from a large number of items, has been studied. JP2018-181326A discloses a personalized product suggestion system utilizing deep learning.

In general, in a case where a suggestion system is introduced into a certain facility or the like, a model of the suggestion system is trained based on data collected at the introduction destination facility or the like. However, in a case where the same suggestion system is introduced in a facility different from the facility where the data used for the training is collected, there is a problem that the prediction accuracy of the model is decreased. The problem that a machine learning model does not work well at unknown other facilities is called domain shift, and research related to domain generalization, which is research on improving robustness against the domain shift, has been active in recent years, mainly in the field of image recognition. However, there have been few research cases on domain generalization in the information suggestion technique.

In the learning and evaluation of the domain generalization, the dataset of the plurality of domains is essential, and the number of domains is preferably large. On the other hand, it is difficult to collect a large amount of data in many domains or the cost is high. Therefore, a technique of generating data in different domains is required.

Qinyong Wang, Hongzhi Yin, Hao Wang, Quoc Viet Hung Nguyen, Zi Huang, Lizhen Cui, “Enhancing Collaborative Filtering with Generative Augmentation” (KDD 2019) discloses a method of generating pseudo user behavior history data using a conditional generative adversarial network (CGAN).

Further, JP2019-526851A discloses a configuration in which proxy data, which is pseudo data, is generated at each facility, and the data is shared with a global server instead of local private data in a case where there is a restriction on data that can be used from a private perspective, such as the patient data of the hospital. According to the technology disclosed in JP2019-526851A, a global model can be trained by using proxy data without sharing real data (private data) having high confidentiality.

### SUMMARY OF THE INVENTION

In Qinyong Wang, Hongzhi Yin, Hao Wang, Quoc Viet Hung Nguyen, Zi Huang, Lizhen Cui, “Enhancing Collaborative Filtering with Generative Augmentation” (KDD 2019), data of a user behavior history necessary for an information suggestion technique can be generated, but only data of the same domain as a source domain (a domain of original data) can be generated. The method disclosed in JP2019-526851A generates a plurality of private data distributions that collectively represent the local private data, and generates a set of the private data and the virtual data (proxy data) that is close to the distribution (in the same domain). In the method disclosed in JP2019-526851A, data of a domain different from the original dataset cannot be generated.

The present disclosure has been made in view of such circumstances, and an object of the present disclosure is to provide an information processing method, an information processing apparatus, and a program capable of generating data of a user behavior history of different domains.

According to one aspect of the present disclosure, there is provided an information processing method executed by one or more processors, the information processing method including: causing the one or more processors to represent a simultaneous probability distribution between a response variable and an explanatory variable, with a behavior for an item of an user as the response variable, for a dataset including a behavior history with respect to a plurality of the items of a plurality of the users, modify a part of the simultaneous probability distribution, and generate data based on the modified simultaneous probability distribution.

According to the present aspect, it is possible to generate data of an explanatory variable and a corresponding response variable from a modified simultaneous probability distribution obtained by modifying a part of the simultaneous probability distribution of the given dataset, and the generated data is data of a domain different from the original dataset. According to the present aspect, it is possible to generate data of a different domain from the original dataset.

In the information processing method according to still another aspect of the present disclosure, the modification may include changing a generation probability distribution of at least a part of the explanatory variables.

In the information processing method according to still another aspect of the present disclosure, the modification may include changing a degree of dependence between variables of the explanatory variables.

In the information processing method according to still another aspect of the present disclosure, the modification may include reflecting a change in a rule that affects the simultaneous probability distribution.

In the information processing method according to still another aspect of the present disclosure, one or more processors may be configured to generate a model that represents the simultaneous probability distribution by performing machine learning using the dataset.

In the information processing method according to still another aspect of the present disclosure, the explanatory variable may include an attribute of the user and an attribute of the item.

In the information processing method according to still another aspect of the present disclosure, the explanatory variable may further include a context.

In the information processing method according to still another aspect of the present disclosure, the representation of the simultaneous probability distribution may include a representation of a conditional probability distribution represented by a function using an inner product between a user characteristic vector represented by using a vector indicating the attribute of the user and an item characteristic vector represented by using a vector indicating the attribute of the item.

In the information processing method according to still another aspect of the present disclosure, the representation of the simultaneous probability distribution may include a representation of a conditional probability distribution represented by a function using a sum of the inner product between the user characteristic vector represented by using the vector indicating the attribute of the user and the item characteristic vector represented by using the vector indicating the attribute of the item, an inner product between the item characteristic vector and a context characteristic vector represented by using a vector indicating an attribute of the context, and an inner product between the context characteristic vector and the user characteristic vector.

In the information processing method according to still another aspect of the present disclosure, the function may be a logistic function.

According to another aspect of the present disclosure, there is provided an information processing apparatus including: one or more processors; and one or more memories in which a command executed by the one or more processors is stored, in which the one or more processors are configured to represent a simultaneous probability distribution between a response variable and an explanatory variable, with a behavior for an item of an user as the response variable, for a dataset including a behavior history with respect to a plurality of the items of a plurality of the users, modify a part of the simultaneous probability distribution, and generate data based on the modified simultaneous probability distribution.

According to still another aspect of the present disclosure, there is provided a program causing a computer to implement: a function of representing a simultaneous probability distribution between a response variable and an explanatory variable, with a behavior for an item of a user as the response variable, for a dataset including a behavior history with respect to a plurality of the items of a plurality of the users; a function of modifying a part of the simultaneous probability distribution; and a function of generating data in accordance with the modified simultaneous probability distribution.

According to the present disclosure, it is possible to generate data of a domain different from a dataset including behavior histories for a plurality of items of a plurality of users.

### BRIEF DESCRIPTION OF THE DRAWINGS

FIG. 1 is a conceptual diagram of a typical suggestion system.

FIG. 2 is a conceptual diagram showing an example of machine learning with a teacher that is widely used in construction of a suggestion system.

FIG. 3 is an explanatory diagram showing a typical introduction flow of the suggestion system.

FIG. 4 is an explanatory diagram of an introduction flow of the suggestion system in a case where data of an introduction destination facility cannot be obtained.

FIG. 5 is an explanatory diagram in a case where a model is trained by domain adaptation.

FIG. 6 is an explanatory diagram of an introduction flow of the suggestion system including a step of evaluating the performance of the trained model.

FIG. 7 is an explanatory diagram showing an example of training data and evaluation data used for the machine learning.

FIG. 8 is a graph schematically showing a difference in performance of a model due to a difference in a dataset.

FIG. 9 is an explanatory diagram of data necessary for developing a domain generalization model.

FIG. 10 is a block diagram schematically showing an example of a hardware configuration of an information processing apparatus according to an embodiment.

FIG. 11 is a functional block diagram showing a functional configuration of the information processing apparatus.

FIG. 12 is a chart showing an example of behavior history data.

FIG. 13 is a diagram showing an example of a directed acyclic graph (DAG) representing a dependency relationship between variables of a simultaneous probability distribution P(X, Y).

FIG. 14 is a diagram showing a specific example of a probability representation of a conditional probability distribution P(Y|X).

FIG. 15 is an explanatory diagram showing a relationship between an expression, which represents a conditional probability of behaviors of a user on an item (Y=1) for a combination of a user behavior characteristic and an item characteristic, and a DAG representing a dependency relationship between variables of the simultaneous probability distribution P(X, Y).

FIG. 16 is an explanatory diagram showing a relationship among a user behavior characteristic defined by a combination of user attribute 1 and user attribute 2, an item behavior characteristic defined by a combination of item attribute 1 and item attribute 2, and a DAG that represents a dependency relationship between variables.

FIG. 17 is a diagram showing an example of a probability distribution P(X) of each attribute of an explanatory variable.

FIG. 18 is a diagram showing an example of a DAG of a simultaneous probability distribution including a context as an explanatory variable.

FIG. 19 is a diagram showing an example of the probability expression of the conditional probability distribution P(Y|X) in consideration of the influence of the context.

FIG. 20 is a graph showing an example of calibration.

FIG. 21 is an explanatory diagram showing Example 1 of a modification method the simultaneous probability distribution.

FIG. 22 is an explanatory diagram showing Example 2 of a modification method the simultaneous probability distribution.

FIG. 23 is an explanatory diagram showing an example of a modified user characteristic vector and an item attribute vector.

FIG. 24 is a flowchart showing a basic procedure of a data generation method using the information processing apparatus according to the embodiment.

FIG. 25 is a flowchart showing a procedure of a method of generating data of a plurality of domains by the information processing apparatus according to the embodiment.

FIG. 26 is a flowchart showing a procedure in a case where data generated by the information processing apparatus according to the embodiment is used for domain generalization learning.

FIG. 27 is a flowchart showing a procedure in a case where data generated by the information processing apparatus according to the embodiment is used to evaluate domain generalization.

### DESCRIPTION OF THE PREFERRED EMBODIMENTS

Hereinafter, preferred embodiments of the present invention will be described with reference to the accompanying drawings.

### <<Overview of Information Suggestion Technique>>

In the present embodiment, a method of generating data of different domains related to user behavior history data used for training and/or an evaluation of a model used in a suggestion system will be described. First, the outline of an information suggestion technique and the necessity of data of a plurality of domains will be overviewed by showing specific examples. The information suggestion technique is a technique for suggesting an item to a user.

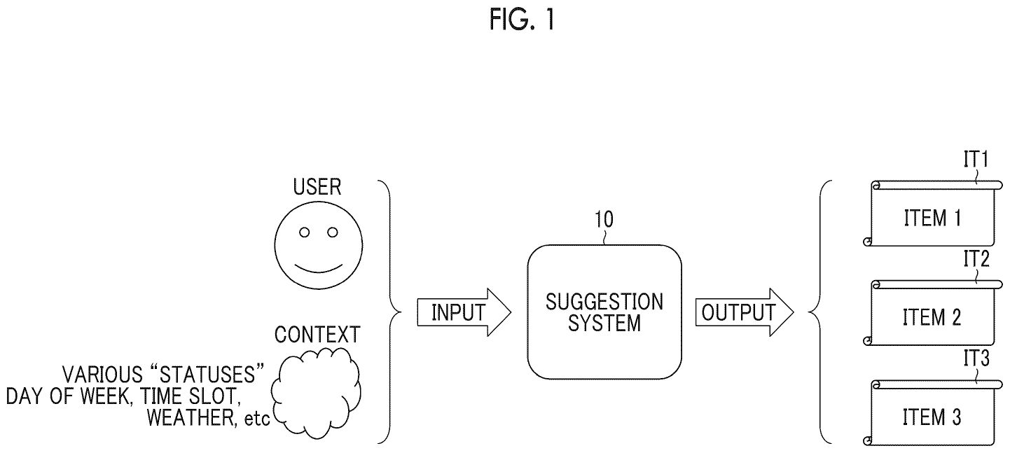

FIG. 1 is a conceptual diagram of a typical suggestion system 10. The suggestion system 10 receives user information and context information as inputs and outputs information of the item that is suggested to the user according to a context. The context means various “statuses” and may be, for example, a day of the week, a time slot, or the weather. The items may be various objects such as a book, a video, a restaurant, and the like.

The suggestion system 10 generally suggests a plurality of items at the same time. FIG. 1 shows an example in which the suggestion system 10 suggests three items of IT1, IT2, and IT3. In a case where the user responds positively to the suggested items IT1, IT2, and IT3, the suggestion is generally considered to be successful. A positive response is, for example, a purchase, browsing, or visit. Such a suggestion technique is widely used, for example, in an EC site, a gourmet site that introduces a restaurant, or the like.

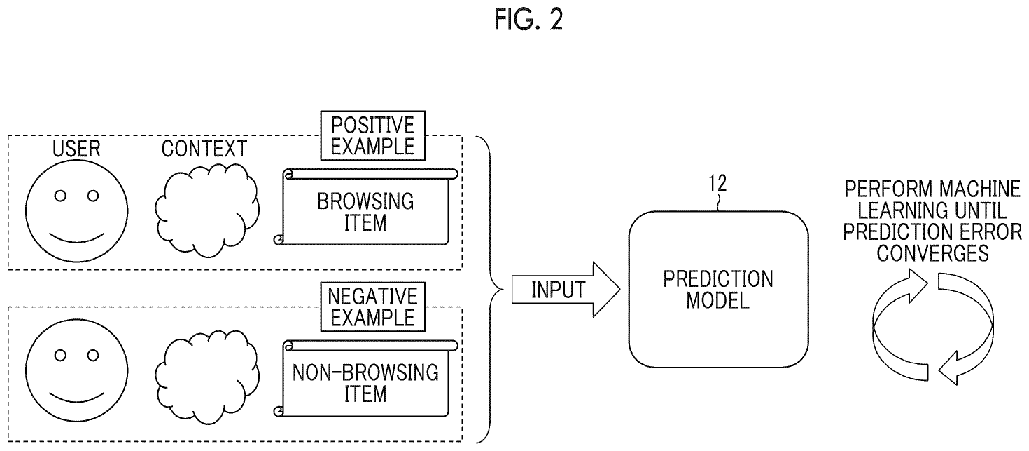

The suggestion system 10 is constructed by using a machine learning technique. FIG. 2 is a conceptual diagram showing an example of machine learning with a teacher that is widely used in construction of the suggestion system 10. Generally, a positive example and a negative example are prepared based on a user behavior history in the past, a combination of the user and the context is input to a prediction model 12, and the prediction model 12 is trained such that a prediction error becomes small. For example, a browsed item that is browsed by the user is defined as a positive example, and a non-browsed item that is not browsed by the user is defined as a negative example. The machine learning is performed until the prediction error converges, and the target prediction performance is acquired.

By using the trained prediction model 12, which is trained in this way, items with a high browsing probability, which is predicted with respect to the combination of the user and the context, are suggested. For example, in a case where a combination of a certain user A and a context B is input to the trained prediction model 12, the prediction model 12 infers that the user A has a high probability of browsing a document such as the item IT3 under a condition of the context B and suggests an item similar to the item IT3 to the user A. Depending on the configuration of the suggestion system 10, items are often suggested to the user without considering the context.

### Example of Data Used for Developing Suggestion System

The user behavior history is substantially equivalent to “correct answer data” in machine learning. Strictly speaking, it is understood as a task setting of inferring the next (unknown) behavior from the past behavior history, but it is general to train the potential feature amount based on the past behavior history.

The user behavior history may include, for example, a book purchase history, a video viewing history, or a restaurant visit history.

Further, main feature amounts include a user attribute and an item attribute. The user attribute may have various elements such as, for example, gender, age group, occupation, family structure, and residential area. The item attribute may have various elements such as a book genre, a price, a video genre, a length, a restaurant genre, and a place.

### [Model Construction and Operation]

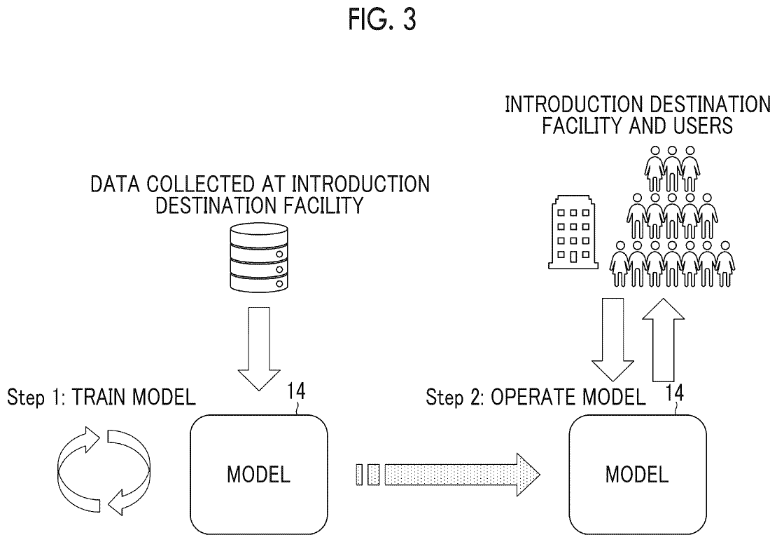

FIG. 3 is an explanatory diagram showing a typical introduction flow of the suggestion system. Here, a typical flow in a case where the suggestion system is introduced to a certain facility, is shown. To introduce the suggestion system, first, a model 14 for performing a target suggestion task is constructed (Step 1), and then the constructed model 14 is introduced and operated (Step 2). In the case of a machine learning model, “constructing” the model 14 includes training the model 14 by using training data to create a prediction model (suggestion model) that satisfies a practical level of suggestion performance. “Operating” the model 14 is, for example, obtaining an output of a suggested item list from the trained model 14 with respect to the input of the combination of the user and the context.

Training data is required for construction of the model 14. As shown in FIG. 3, in general, the model 14 of the suggestion system is trained based on the data collected at an introduction destination facility. By performing training by using the data collected from the introduction destination facility, the model 14 learns the behavior of the user in the introduction destination facility and can accurately predict suggestion items for the user in the introduction destination facility.

However, due to various circumstances, it may not be possible to obtain data on the introduction destination facility. For example, in the case of a document information suggestion system in an in-house system of a company or an in-hospital system of a hospital, a company that develops a suggestion model often cannot access the data of the introduction destination facility. In a case where the data of the introduction destination facility cannot be obtained, instead, it is necessary to perform training based on data collected at different facilities.

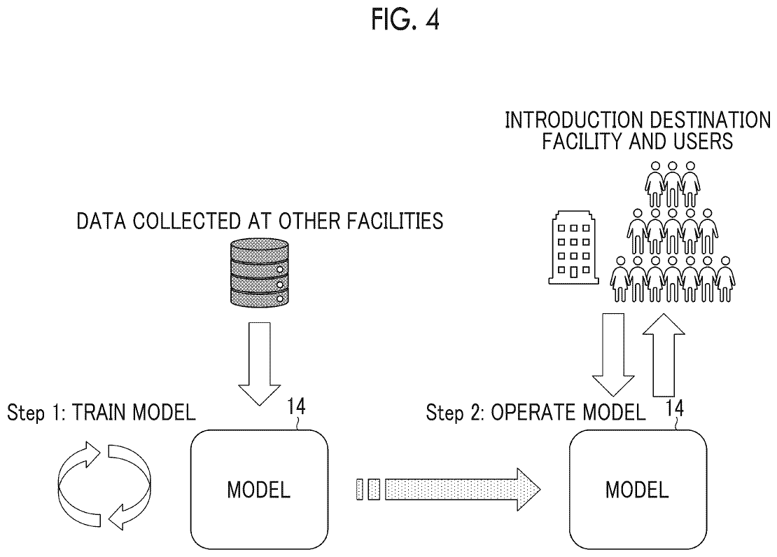

FIG. 4 is an explanatory diagram of an introduction flow of the suggestion system in a case where data of an introduction destination facility cannot be obtained. In a case where the model 14, which is trained by using the data collected at a facility different from the introduction destination facility, is operated in the introduction destination facility, there is a problem that the prediction accuracy of the model 14 decreases due to differences in user behavior between facilities.

The problem that the machine learning model does not work well in unknown facilities different from the trained facility is understood as a technical problem, in a broad sense, to improve robustness against a problem of domain shift in which a source domain where the model 14 is trained differs from a target domain where the model 14 is applied. Domain adaptation is a problem setting related to domain generalization. This is a method of training by using data from both the source domain and the target domain. The purpose of using the data of different domains in spite of the presence of the data of the target domain is to make up for the fact that the amount of data of the target domain is small and insufficient for training.

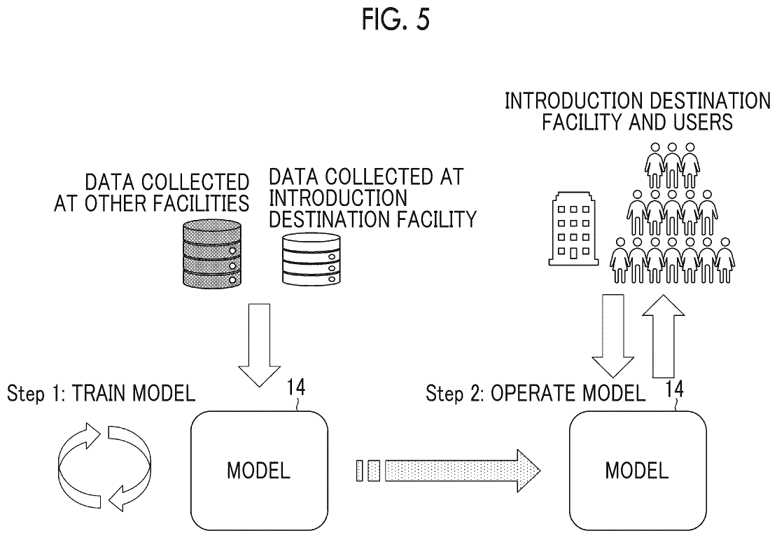

FIG. 5 is an explanatory diagram in a case where the model 14 is trained by domain adaptation. Although the amount of data collected at the introduction destination facility that is the target domain is relatively smaller than the data collected at a different facility, the model 14 can also predict with a certain degree of accuracy the behavior of the users in the introduction destination facility by performing a training by using both data. [Description of Domain]

The above-mentioned difference in a “facility” is a kind of difference in a domain. In Ivan Cantador et al, Chapter 27: “Cross-domain Recommender System”, which is a document related to research on domain adaptation in information suggestion, differences in domains are classified into the following four categories.
[1] Item attribute level: For example, a comedy movie and a horror movie are in different domains.
[2] Item type level: For example, a movie and a TV drama series are in different domains.
[3] Item level: For example, a movie and a book are in different domains.
[4] System level: For example, a movie in a movie theater and a movie broadcast on television are in different domains.

The difference in “facility” shown in FIG. 5 or the like corresponds to [4] system-level domain in the above four categories.

In a case where a domain is formally defined, the domain is defined by a simultaneous probability distribution P(X, Y) of a response variable Y and an explanatory variable X, and in a case where Pd1(X, Y)≠Pd2(X, Y), d1 and d2 are different domains.

The simultaneous probability distribution P(X, Y) can be represented by a product of an explanatory variable distribution P(X) and a conditional probability distribution P(Y|X) or a product of a response variable distribution P(Y) and a conditional probability distribution P(Y|X).

P(X,Y)=P(Y|X)P(X)=P(X|Y)P(Y)

Therefore, in a case where one or more of P(X), P(Y), P(Y|X), and P(X|Y) is changed, the domains become different from each other.

### [Typical Pattern of Domain Shift]

[Covariate shift] A case where distributions P(X) of explanatory variables are different is called a covariate shift. For example, a case where distributions of user attributes are different between datasets, more specifically, a case where a gender ratio is different, and the like correspond to the covariate shift.

[Prior probability shift] A case where distributions P(Y) of the response variables are different is called a prior probability shift. For example, a case where an average browsing rate or an average purchase rate differs between datasets corresponds to the prior probability shift.

[Concept shift] A case where conditional probability distributions P(Y|X) and P(X|Y) are different is called a concept shift. For example, a probability that a research and development department of a certain company reads data analysis materials is assumed as P(Y|X), and in a case where the probability differs between datasets, this case corresponds to the concept shift.

Research on domain adaptation or domain generalization includes assuming one of the above-mentioned patterns as a main factor and looking at dealing with P(X, Y) changing without specifically considering which pattern is a main factor. In the former case, there are many cases in which a covariate shift is assumed.

### [Reason for Influence of Domain Shift]

A prediction/classification model that performs a prediction or classification task makes inferences based on a relationship between the explanatory variable X and the response variable, thereby in a case where P(Y|X) is changed, naturally the prediction/classification performance is decreased. Further, although minimization of a prediction/classification error is performed within training data in a case where machine learning is performed on the prediction/classification model, for example, in a case where the frequency in which the explanatory variable becomes X=X_1 is greater than the frequency in which the explanatory variable becomes X=X_2, that is, in a case where P(X=X_1)>P(X=X_2), the data of X=X_1 is more than the data of X=X_2, thereby error decrease for X=X_1 is trained in preference to error decrease for X=X_2. Therefore, even in a case where P(X) is changed between the facilities, the prediction/classification performance is decreased.

The domain shift can be a problem not only for information suggestions but also for various task models. For example, regarding a model that predicts the retirement risk of an employee, a domain shift may become a problem in a case where a prediction model, which is trained by using data of a certain company, is operated by another company.

Further, in a model that predicts an antibody production amount of a cell, a domain shift may become a problem in a case where a model, which is trained by using data of a certain antibody, is used for another antibody. Further, for a model that classifies the voice of customer (VOC), for example, a model that classifies VOC into “product function”, “support handling”, and “other”, a domain shift may be a problem in a case where a classification model, which is trained by using data related to a certain product, is used for another product. [Regarding Evaluation before Introduction of Model]

In many cases, a performance evaluation is performed on the model 14 before the trained model 14 is introduced into an actual facility or the like. The performance evaluation is necessary for determining whether or not to introduce the model and for research and development of models or learning methods.

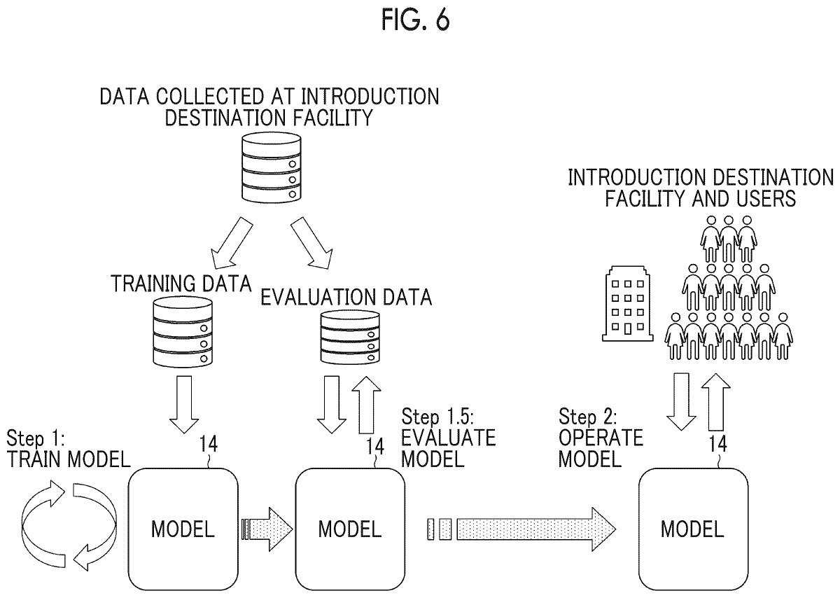

FIG. 6 is an explanatory diagram of an introduction flow of the suggestion system including a step of evaluating the performance of the trained model 14. In FIG. 6, a step of evaluating the performance of the model 14 is added as “step 1.5” between Step 1 (the step of training the model 14) and Step 2 (the step of operating the model 14) described in FIG. 5. Other configurations are the same as in FIG. 5. As shown in FIG. 6, in a general introduction flow of the suggestion system, the data, which is collected at the introduction destination facility, is often divided into training data and evaluation data. The prediction performance of the model 14 is checked by using the evaluation data, and then the operation of the model 14 is started.

However, in a case of constructing the domain generalization model 14, the training data and the evaluation data need to be different domains. Further, in the domain generalization, it is preferable to use the data of a plurality of domains as the training data, and it is more preferable that there are many domains that can be used for training.

### [Regarding Generalization]

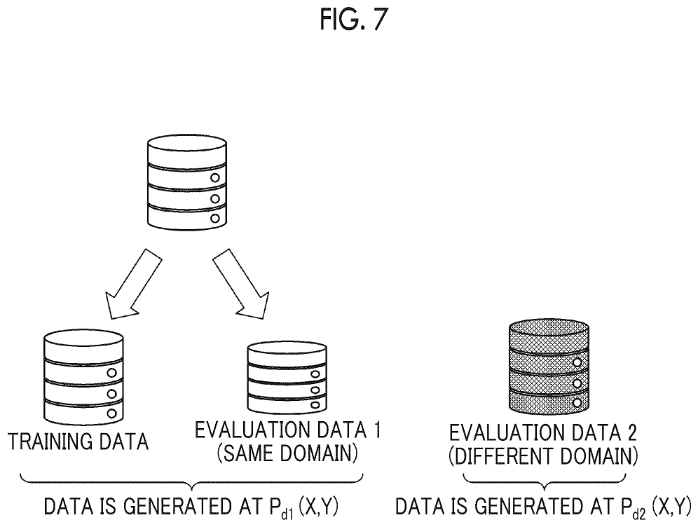

FIG. 7 is an explanatory diagram showing an example of the training data and the evaluation data used for the machine learning. The dataset obtained from the simultaneous probability distribution Pd1(X, Y) of a certain domain d1 is divided into training data and evaluation data. The evaluation data of the same domain as the training data is referred to as “first evaluation data” and is referred to as “evaluation data 1” in FIG. 7. Further, a dataset, which is obtained from a simultaneous probability distribution Pd2(X, Y) of a domain d2 different from the domain d1, is prepared and is used as the evaluation data. The evaluation data of the domain different from the training data is referred to as “second evaluation data” and is referred to as “evaluation data 2” in FIG. 7.

The model 14 is trained by using the training data of the domain d1, and the performance of the model 14, which is trained by using each of the first evaluation data of the domain d1 and the second evaluation data of the domain d2, is evaluated.

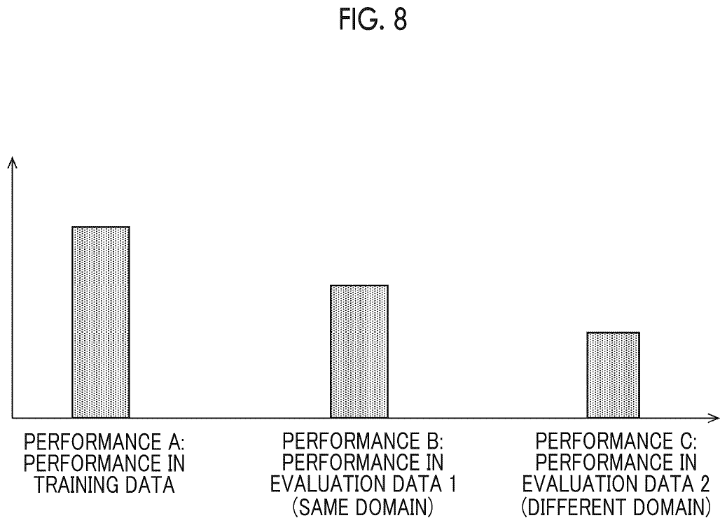

FIG. 8 is a graph schematically showing a difference in performance of the model due to a difference in the dataset. Assuming that the performance of the model 14 in the training data is defined as performance A, the performance of the model 14 in the first evaluation data is defined as performance B, and the performance of the model 14 in the second evaluation data is defined as performance C, normally, a relationship is represented such that performance A>performance B>performance C, as shown in FIG. 8.

High generalization performance of the model 14 generally indicates that the performance B is high, or indicates that a difference between the performances A and B is small. That is, the aim is to achieve high prediction performance even for unlearned data without over-fitting to the training data.

In the context of domain generalization in the present specification, it means that the performance C is high or a difference between the performance B and the performance C is small. In other words, the aim is to achieve high performance consistently even in a domain different from the domain used for the training.

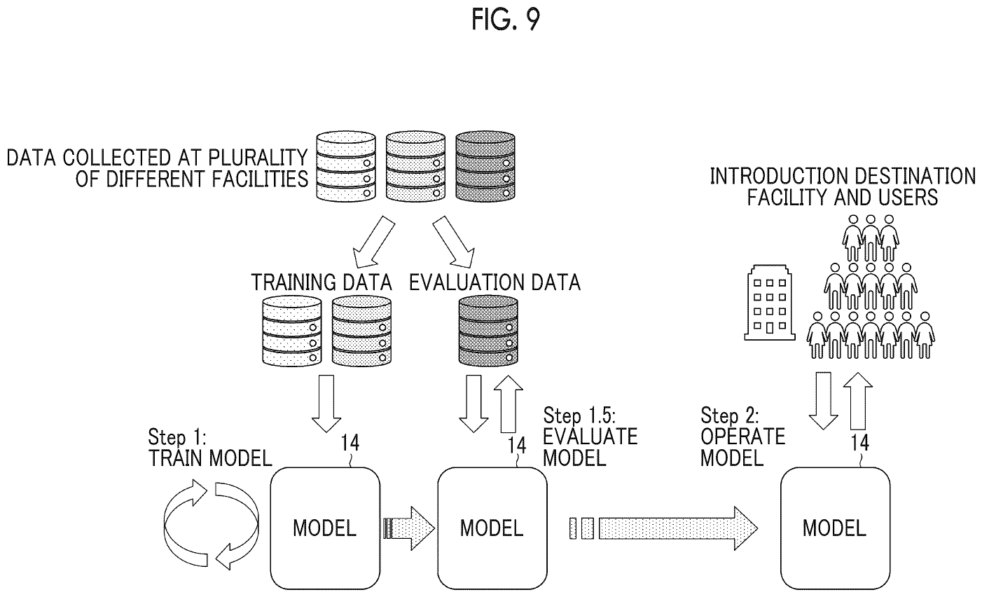

FIG. 9 is an explanatory diagram of data necessary for developing a domain generalization model. In order to develop the domain generalization model 14, as shown in FIG. 9, it is preferable to prepare data collected at a plurality of different facilities, use a dataset of a plurality of domains as training data, and use a dataset of domains further different from the plurality of domains as evaluation data.

### [Problems]

As described above, in order to develop a model having a robust performance in a plurality of facilities, basically, data of a plurality of facilities is required. However, in reality, it is often difficult to prepare data of a plurality of different facilities. It is desired to realize a model having domain generalization even in a case where the number of domains that can be utilized for training or evaluation of the model is small or even in a case where there is only one piece of data of one domain. In the present embodiment, even in a case where there is only data of one domain, a method of generating data of other domains in a pseudo method is provided.

### Outline of Information Processing Apparatus According to Embodiment

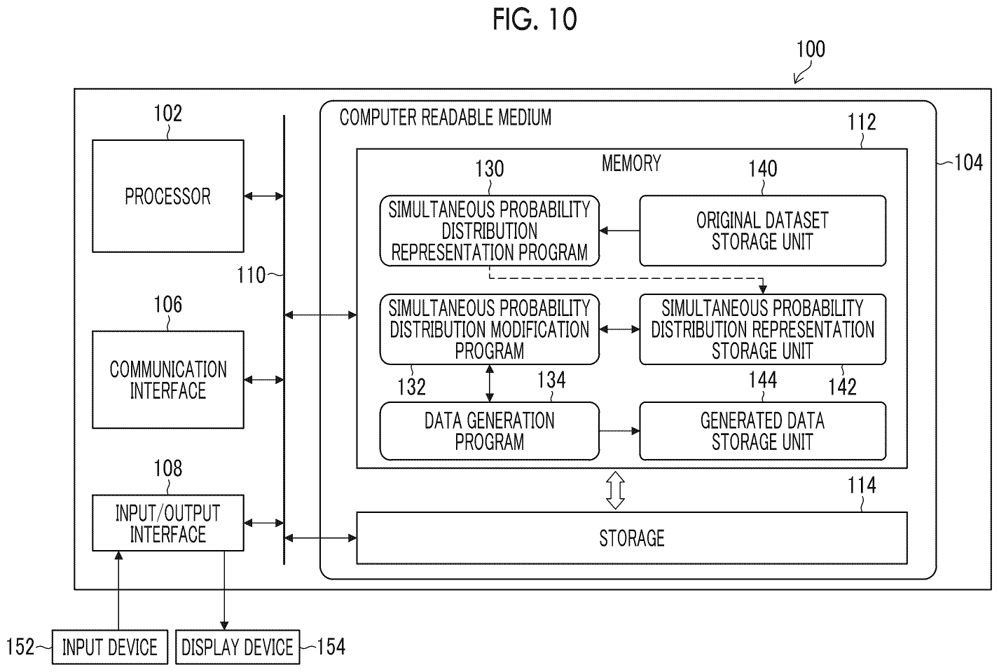

FIG. 10 is a block diagram schematically showing an example of a hardware configuration of an information processing apparatus 100 according to an embodiment. The information processing apparatus 100 has a function of expressing a simultaneous probability distribution between a response variable and a plurality of explanatory variables, a function of modifying a part of the simultaneous probability distribution, and a function of generating data in accordance with the modified simultaneous probability distribution, for a dataset consisting of behavior histories for a plurality of items of a plurality of users.

The information processing apparatus 100 can be realized by using hardware and software of a computer. The physical form of the information processing apparatus 100 is not particularly limited, and may be a server computer, a workstation, a personal computer, a tablet terminal, or the like. Although an example of realizing a processing function of the information processing apparatus 100 using one computer will be described here, the processing function of the information processing apparatus 100 may be realized by a computer system configured by using a plurality of computers.

The information processing apparatus 100 includes a processor 102, a computer-readable medium 104 that is a non-transitory tangible object, a communication interface 106, an input/output interface 108, and a bus 110.

The processor 102 includes a central processing unit (CPU). The processor 102 may include a graphics processing unit (GPU). The processor 102 is connected to the computer-readable medium 104, the communication interface 106, and the input/output interface 108 via the bus 110. The processor 102 reads out various programs, data, and the like stored in the computer-readable medium 104 and executes various processes. The term program includes the concept of a program module and includes commands conforming to the program.

The computer-readable medium 104 is, for example, a storage device including a memory 112 which is a main memory and a storage 114 which is an auxiliary storage device. The storage 114 is configured using, for example, a hard disk drive (HDD) device, a solid state drive (SSD) device, an optical disk, a photomagnetic disk, a semiconductor memory, or an appropriate combination thereof. Various programs, data, or the like are stored in the storage 114.

The memory 112 is used as a work area of the processor 102 and is used as a storage unit that temporarily stores the program and various types of data read from the storage 114. By loading the program that is stored in the storage 114 into the memory 112 and executing commands of the program by the processor 102, the processor 102 functions as a unit for performing various processes defined by the program. The memory 112 stores various programs, such as a simultaneous probability distribution representation program 130, a simultaneous probability distribution modification program 132, and a data generation program 134, and various data, which are executed by the processor 102.

The memory 112 includes an original dataset storage unit 140, a simultaneous probability distribution representation storage unit 142, and a generated data storage unit 144. The original dataset storage unit 140 is a storage region in which a dataset (hereinafter, referred to as an original dataset) serving as a basis for generating data in different domains is stored. The simultaneous probability distribution representation storage unit 142 is a storage region in which the simultaneous probability distribution representation represented by the simultaneous probability distribution representation program 130 and the simultaneous probability distribution representation modified by the simultaneous probability distribution modification program 132 are stored with respect to the original dataset. The generated data storage unit 144 is a storage region in which the data of the pseudo behavior history generated by the data generation program 134 is stored.

The communication interface 106 performs a communication process with an external device by wire or wirelessly and exchanges information with the external device. The information processing apparatus 100 is connected to a communication line (not shown) via the communication interface 106. The communication line may be a local area network, a wide area network, or a combination thereof. The communication interface 106 can play a role of a data acquisition unit that receives input of various data such as the original dataset.

The information processing apparatus 100 may include an input device 152 and a display device 154. The input device 152 and the display device 154 are connected to the bus 110 via the input/output interface 108. The input device 152 may be, for example, a keyboard, a mouse, a multi-touch panel, or other pointing device, a voice input device, or an appropriate combination thereof. The display device 154 may be, for example, a liquid crystal display, an organic electro-luminescence (OEL) display, a projector, or an appropriate combination thereof. The input device 152 and the display device 154 may be integrally configured as in the touch panel, or the information processing apparatus 100, the input device 152, and the display device 154 may be integrally configured as in the touch panel type tablet terminal.

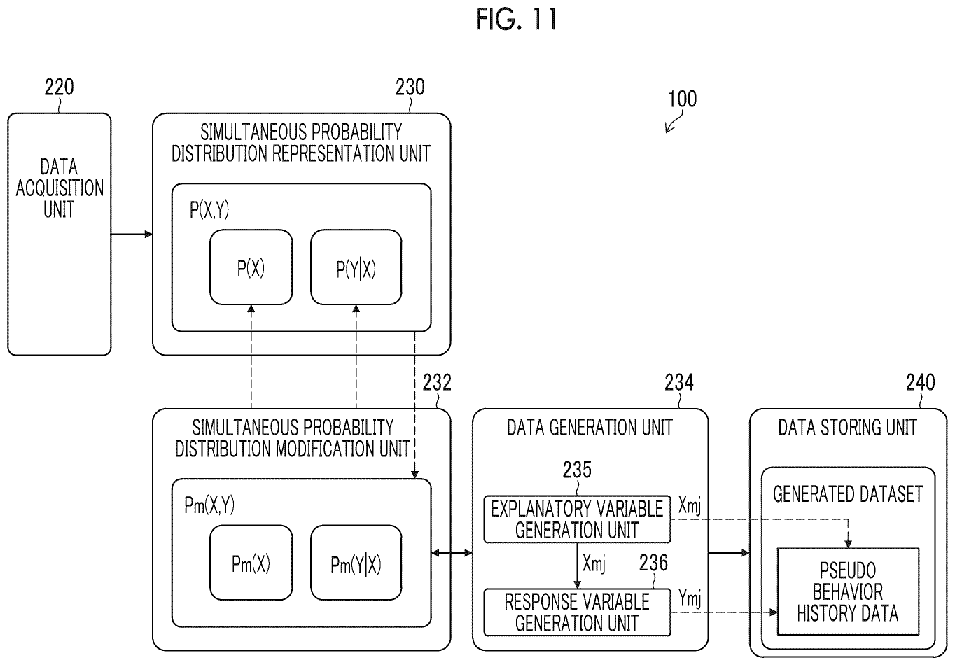

FIG. 11 is a functional block diagram showing a functional configuration of an information processing apparatus 100. The information processing apparatus 100 includes a data acquisition unit 220, a simultaneous probability distribution representation unit 230, a simultaneous probability distribution modification unit 232, a data generation unit 234, and a data storing unit 240. The data acquisition unit 220 acquires a dataset of the behavior history for each item of the plurality of users in the first domain, which is an original dataset. The simultaneous probability distribution representation unit 230 models the dependency relationship between the response variable Y and each explanatory variable X with respect to the original dataset, and obtains the simultaneous probability distribution P(X,Y) between the response variable Y and each explanatory variable X.

The simultaneous probability distribution modification unit 232 modifies a part of the simultaneous probability distribution P(X,Y) of the first domain to generate a modified simultaneous probability distribution Pm(X,Y). The simultaneous probability distribution modification unit 232 may modify the conditional probability distribution P(Y|X), the probability distribution P(X) of the explanatory variable X, or both of the conditional probability distribution P(Y|X) and the probability distribution P(X) of the explanatory variable X. The modified simultaneous probability distribution Pm(X, Y) corresponds to the simultaneous probability distribution between the response variable Y and each of the explanatory variables X in a pseudo domain (second domain) different from the first domain.

The data generation unit 234 generates data of the pseudo behavior history for each item of the plurality of pseudo users in accordance with the modified simultaneous probability distribution Pm(X,Y). The data generation unit 234 includes an explanatory variable generation unit 235 and a response variable generation unit 236. The explanatory variable generation unit 235 generates the explanatory variables Xmj in accordance with the probability distribution Pm(X) in the modified simultaneous probability distribution Pm(X,Y). The response variable generation unit 236 generates the response variable Ymj in accordance with the conditional probability distribution Pm(Y|X) in the modified simultaneous probability distribution Pm(X, Y) on the basis of the explanatory variable Xmj. The data generation unit 234 can generate a large amount of pseudo user behavior history data.

The pseudo behavior history data generated by the data generation unit 234 is stored in the data storing unit 240. The data storing unit 240 stores a generated dataset including the pseudo behavior history data of a large number of pseudo users. The generated data storage unit 144 (refer to FIG. 10) may function as a data storing unit 240.

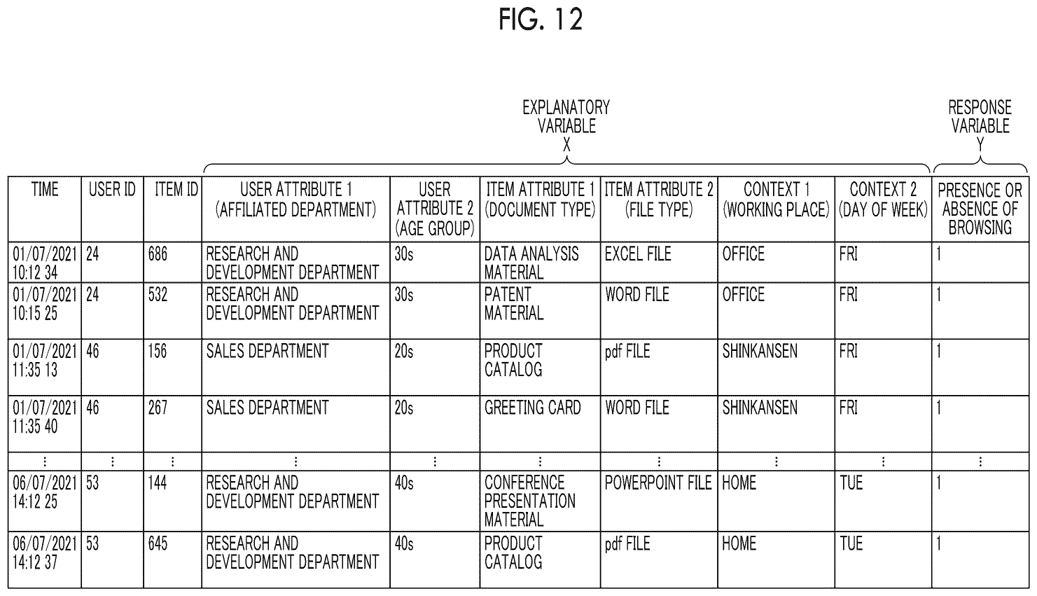

FIG. 12 is a chart showing an example of behavior history data. Here, a case of the behavior history in a document browsing system in a company is considered. FIG. 12 shows an example of a table of a user behavior history related to browsing the document obtained from a document browsing system of a certain company. The “item” here is a document. The table shown in FIG. 12 includes columns of “time”, “user ID”, “item ID”, “user attribute 1”, “user attribute 2”, “item attribute 1”, “item attribute 2”, “context 1”, “context 2”, and “presence or absence of purchase”.

The “time” is the date and time when the item is browsed. The “user ID” is an identification code that specifies a user, and an identification (ID) that is unique to each user is defined. The item ID is an identification code that specifies an item, and an ID that is unique to each item is defined. The “user attribute 1” is, for example, an affiliated department of a user. The “user attribute 2” is, for example, an age group of a user. The “item attribute 1” is, for example, a document type as a classification category of items. The “item attribute 2” is, for example, a file type of an item. The “context 1” is, for example, a work place where an item is viewed. The “context 2” is, for example, a day of the week on which the item is viewed. A value of “presence or absence of browsing” in a case of being browsed (presence of browsing) is “1”. Since the number of items that are not browsed is enormous, it is common to record only the browsed item (presence or absence of browsing=1) in the record.

The “presence or absence of browsing” in FIG. 12 is an example of the response variable Y, and each of the “user attribute 1”, “user attribute 2”, “item attribute 1”, “item attribute 2”, “context 1”, and “context 2” is an example of the explanatory variable X. The number of types of the explanatory variables X and the combination thereof are not limited to the example of FIG. 12. The explanatory variable X may further include a user attribute 3, an item attribute 3, a context 3, and the like, which are not shown, or may be an aspect in which “context 1” and “context 2” are not included in the explanatory variable X.

### [Outline of Information Processing Method]

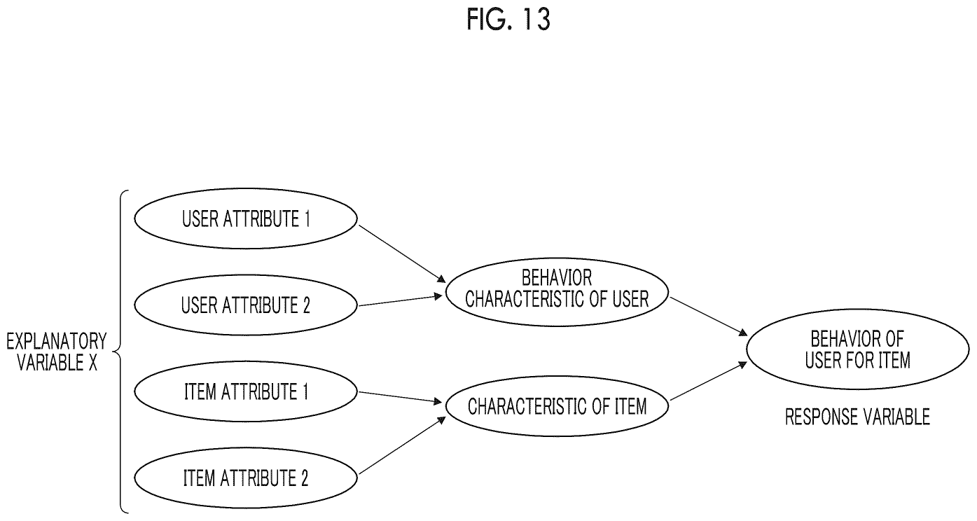

For example, in a case where there is data, such as a table shown in FIG. 12, as the behavior history, the processor 102 first learns the dependency between the variables based on the data (refer to FIGS. 13 to 18). More specifically, the processor 102 expresses the user, the item, and the context as vectors, uses a model in which the sum of inner products is the behavior probability, and updates the parameters of the model to minimize the error of the behavior prediction. The vector representation of users is represented by, for example, the addition of the vector representation of each attribute of the user. The same applies to the vector representation of the item and the vector representation of the context. The model in which the dependency between the variables is trained corresponds to representation of the simultaneous probability distribution P(X, Y) between the response variable Y and each explanatory variable X in the dataset of the given behavior history.

Next, the processor 102 performs modification of the dependency between the variables. For example, in consideration of the possibility that another company may further promote telework, the probability of telework for the context 1 (workplace) is increased. In addition, for example, a company with few elements in the seniority sequence is assumed to eliminate dependence on the age group. Specifically, an age group attribute is not added in a case of configuring the vector representation of the user.

Moreover, the processor 102 generates data of a pseudo behavior history on the basis of the modified dependency. The processor 102 stochastically generates data from an upstream of a dependency relationship between variables. That is, first, the processor 102 generates attribute data according to a probability distribution, and obtains a vector representation of a user, an item, a context, or the like based on the generated attribute. Thereafter, the processor 102 generates the presence or absence of the behavior for a combination of the user, the item, and the context in accordance with the behavior probability calculated from the sum of the inner products of the vectors. In this way, data of a domain different from the real dataset used for learning (dataset as actually collected from the company as shown in FIG. 12) is generated.

### Example of Method of Representing Dependency Between Variables

FIG. 13 is an example of a directed acyclic graph (DAG) representing a dependency relationship between variables of a simultaneous probability distribution P(X, Y). FIG. 13 shows an example in which four variables, user attribute 1, user attribute 2, item attribute 1, and item attribute 2 are used as the explanatory variables X. The relationship between each of these explanatory variables X and the behavior of the user on the item, which is the response variable Y, is represented by, for example, a graph as shown in FIG. 13.

The simultaneous probability distribution representation unit 230 acquires a vector representation of the simultaneous probability distribution P(X,Y) based on, for example, the dependency relationship between the variables as in the DAG shown in FIG. 13. The graph shown in FIG. 13 shows that the behavior of the user on the item, which is the response variable, depends on the user behavior characteristic and the item characteristic, shows that the user behavior characteristic depends on user attribute 1 and user attribute 2, and shows that the item characteristic depends on item attribute 1 and item attribute 2.

As shown in FIG. 13, the combination of the user attribute 1 and the user attribute 2 defines the user behavior characteristic. Further, the combination of the item attribute 1 and the item attribute 2 defines the item characteristic. The behavior of the user on the item is defined by a combination of the user behavior characteristic and the item characteristic.

In general, the relationship of P(X, Y)=P(X)×P(Y|X) is established, and in a case where the graph in FIG. 13 is applied to this expression, it is represented as follows.

$$P ( X ) = P ( user attribute 1 , user attribute 2 , item attribute 1 , item attribute 2 )$$

$$P ( Y \vert X ) = P ( behavior of user on item \vert user attribute 1 , user attribute 2 , item attribute 1 , item attribute 2 )$$

$$P ( X , Y ) = P ( user attribute 1 , user attribute 2 , item attribute 1 , item attribute 2 ) \times P ( behavior of user on item \vert user attribute 1 , user attribute 2 , item attribute 1 , item attribute 2 )$$

Further, the graph shown in FIG. 13 indicates that the elements can be decomposed as follows.

$$P ( Y \vert X ) = P ( behavior of user on item \vert user behavior characteristic , item characteristic ) \times P ( user behavior characteristic \vert user attribute 1 , user attribute 2 ) \times P ( item behavior characteristic \vert item attribute 1 , item attribute 2 )$$

### Example of Probability Representation of Conditional Probability Distribution P(Y|X)

For example, the simultaneous probability distribution representation unit 230 represents the probability that the user views (Y=1) the item by the sigmoid function of the inner product of the user characteristic vector and the item characteristic vector. Such a representation method is called a matrix factorization. The reason why the sigmoid function is adopted is that a value of the sigmoid function can be in a range of 0 to 1 and a value of the function can directly correspond to the probability. The sigmoid function is an example of a “function” according to the present disclosure. The present embodiment is not limited to the sigmoid function, a model representation using another function may be used.

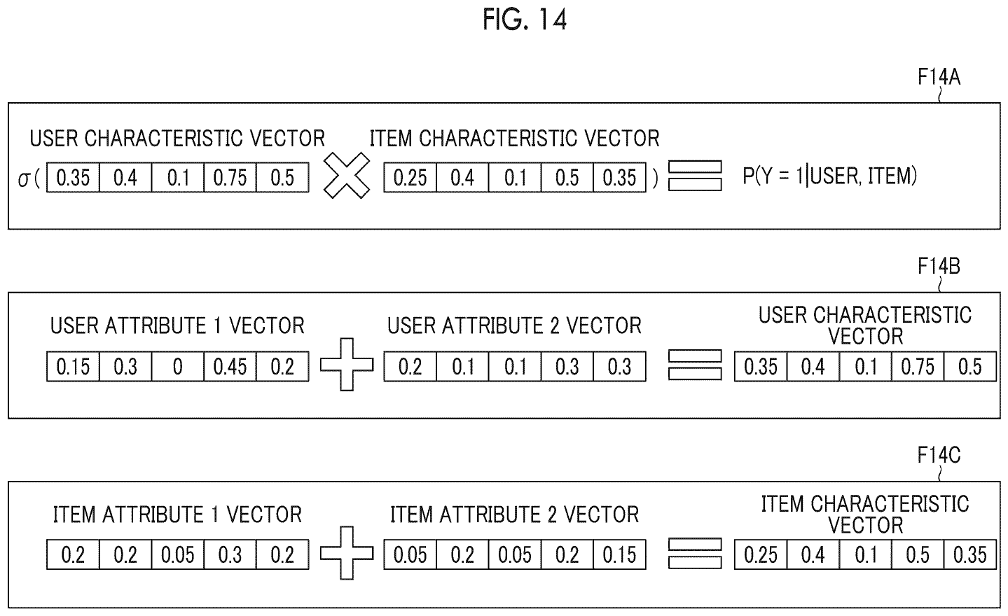

FIG. 14 shows a specific example of the probability representation of P(Y|X). The expression F14A shown in the upper part in FIG. 14 is an example of an expression that represents each of the user characteristic vector θu and the item characteristic vector φi as a five-dimensional vector and represents a sigmoid function σ(θu·φi) of these inner products (θu·φi) as a conditional probability P(Y=1|user, item) by using the matrix factorization.

“u” is an index value that distinguishes the users. “i” is an index value that distinguishes the items. The dimension of the vector is not limited to 5 dimensions, and is set to an appropriate number of dimensions as a hyperparameter of the model.

The user characteristic vector θu is represented by adding up attribute vectors of the users. For example, as in the expression F14B shown in the middle part in FIG. 14, the user characteristic vector θu is represented by the sum of the user attribute 1 vector and the user attribute 2 vector. Further, the item characteristic vector φi is represented by adding attribute vectors of the items. For example, as in the expression F14C shown in the lower part in FIG. 14, the item characteristic vector φi is represented by the sum of the item attribute 1 vector and the item attribute 2 vector. The value of each vector is determined by learning from a dataset (training data) of the user behavior history of the given domain.

For example, the vector values are updated, for example, by using a stochastic gradient descent (SGD) method such that, P(Y=1|user, item) becomes large for a pair of browsed user and item, and P(Y=1|user, item) becomes small for a pair of non-browsed user and item.

Regarding a method of learning the simultaneous probability distribution representation from data, a case where P(Y|X) is represented by matrix factorization of FIG. 14 will be described. A method of expressing the simultaneous probability distribution is not limited to matrix factorization, and may be any method as long as the conditional probability P(Y|X) can be predicted. For example, instead of the matrix factorization, logistic regression, naive bayes, or the like may be applied. In the case of any prediction model, by performing calibration such that an output score is close to the probability P(Y|X), it can be used as a method of the simultaneous probability distribution representation. For example, a support vector machine (SVM), a gradient boosting decision tree (GDBT), and a neural network model having any architecture can also be used. In addition, an ensemble of a plurality of prediction models may be used as the simultaneous probability distribution representation.

In the case of the simultaneous probability distributions P(X, Y) shown in FIG. 13 and FIG. 14, the parameters to be trained from the data are as shown below.
User characteristic vector: θu
Item characteristic vector: φi
User attribute 1 vector: Vk_u\hat{ }1
User attribute 2 vector: Vk_u\hat{ }2
Item attribute 1 vector: Vk_i\hat{ }1
Item attribute 2 vector: Vk_i\hat{ }2

However, these parameters satisfy the following relationships.

$$\cdot θ u = Vk\_u \hat{} 1 + Vk\_u \hat{} 2$$

$$\cdot φ i = Vk\_i \hat{} 1 + Vk\_i \hat{} 2$$

“k” is an index value that distinguishes the attributes. For example, assuming that the user attribute 1 has 10 types of affiliated departments, the user attribute 2 has age group 6 levels, the item attribute 1 has 20 types of document type, and the item attribute 2 has 5 file types, since the types of attributes are 10+6+20+5=41, the possible value of “k” is 1 to 41. For example, in a case where k=1, it corresponds to a sales department of the user attribute 1, and an index value of the user attribute 1 of the user “u” is represented as k_u\hat{ }1.

The values of each of the vectors of the user attribute 1 vector Vk_u\hat{ }1, the user attribute 2 vector Vk_u\hat{ }2, the item attribute 1 vector Vk_i\hat{ }1, and the item attribute 2 vector Vk_i\hat{ }2 are obtained by training from the training data.

As a loss function in the case of a training, for example, log loss that is represented by the following Expression (1) is used.

$$L = - \{ Y log σ ( θ u \cdot φ i ) + ( 1 - Y ) log ( 1 - σ ( θ u \cdot φi ) \} \qquad ( 1 )$$

In a case where the user “u” browses the item “i”, Y=1, and the larger the prediction probability σ(θu·φi), the smaller the loss L. On the contrary, in a case where the user “u” does not browse the item “i”, Y=0, and the smaller σ(θu·φi), the smaller the loss L.

The simultaneous probability distribution representation unit 230 learns the parameters of the vector representation such that the loss L is reduced. For example, in a case where optimization is performed by a stochastic gradient descent method, the simultaneous probability distribution representation unit calculates a partial derivative (gradient) of each parameter with respect to the loss function and changes the parameter in a direction in which the loss L is smaller in proportion to the magnitude of the gradient.

For example, the simultaneous probability distribution representation unit 230 updates the parameters of the user attribute 1 vector (Vk_u\hat{ }1) in accordance with Expression (2).

$${V}_{k\_u \hat{} 1} - α \frac{\partial }{\partial {V}_{k\_u \hat{} 1}} L \qquad ( 2 )$$

“α” in Expression (2) is a learning speed.

In general, since items with Y=0 are overwhelmingly more than items with Y=1 among many items, in a case where the behavior history data is stored as a table as shown in FIG. 12, only Y=1 is stored, and the pair of user “u” and item “i” that are not included in the behavior history data is learned as Y=0. That is, by storing only the data of the positive example, the negative example can be easily generated as not included in the data of the positive example.

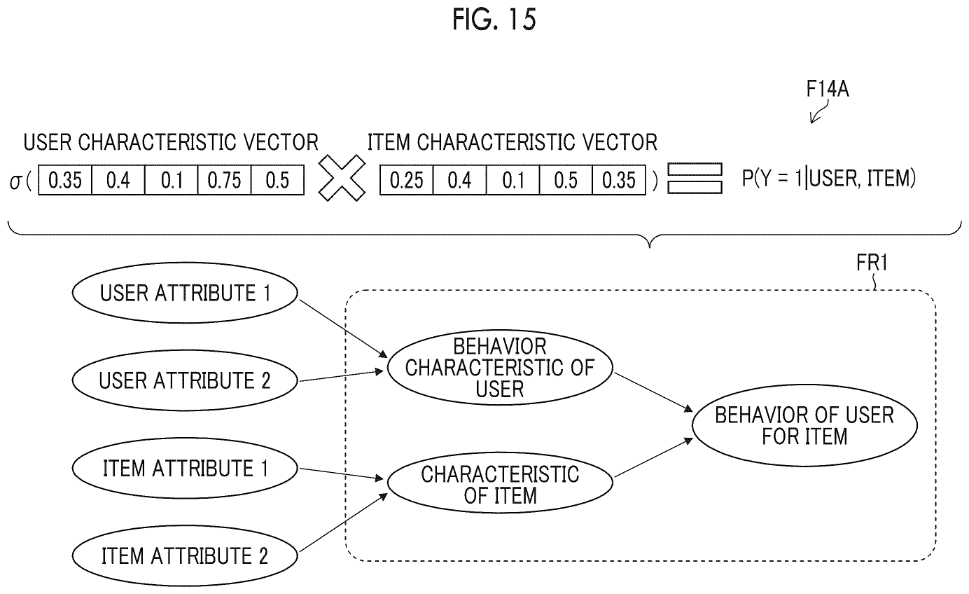

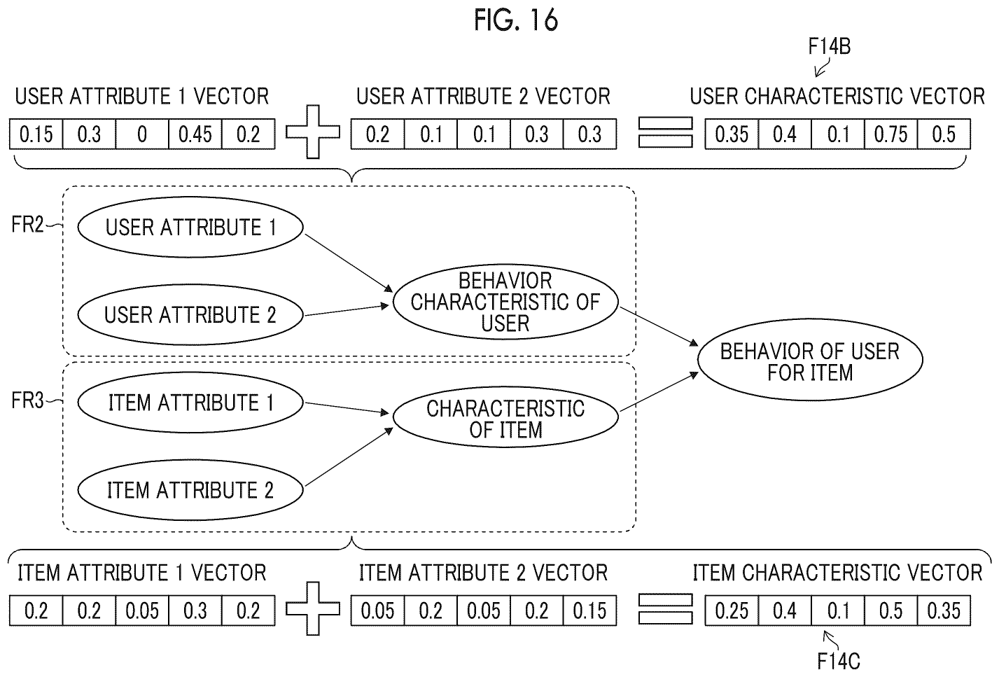

FIG. 15 is an explanatory diagram showing a relationship between the expression F14A representing a conditional probability of a behavior of a user on an item (Y=1) for a combination of a user behavior characteristic and an item characteristic, and a DAG representing a dependency relationship between variables of the simultaneous probability distribution P(X, Y). As shown in FIG. 15, the expression F14A represents the conditional probability of a portion of the DAG shown in FIG. 15 surrounded by a broken line frame FR1. FIG. 16 is an explanatory diagram showing a relationship among a user behavior characteristic defined by a combination of user attribute 1 and user attribute 2, an item behavior characteristic defined by a combination of item attribute 1 and item attribute 2, and a DAG that represents a dependency relationship between variables. As shown in FIG. 16, the expression F14B represents a relationship in a portion surrounded by a frame FR2 indicated by a broken line in the DAG shown in FIG. 16. Further, the expression F14C represents a relationship in a portion surrounded by a frame FR3 indicated by a broken line in the DAG shown in FIG. 16.

### [Regarding Probability Distribution P(X) of Each Attribute of User Attribute and Item Attribute]

In the simultaneous probability distribution P(X,Y), not only P(Y|X) but also the representation of P(X) is required. As the probability P(X) of each attribute, a ratio of the attribute values existing in the training data may be used. The training data referred to herein means an original dataset used for learning for obtaining the simultaneous probability distribution P(X,Y).

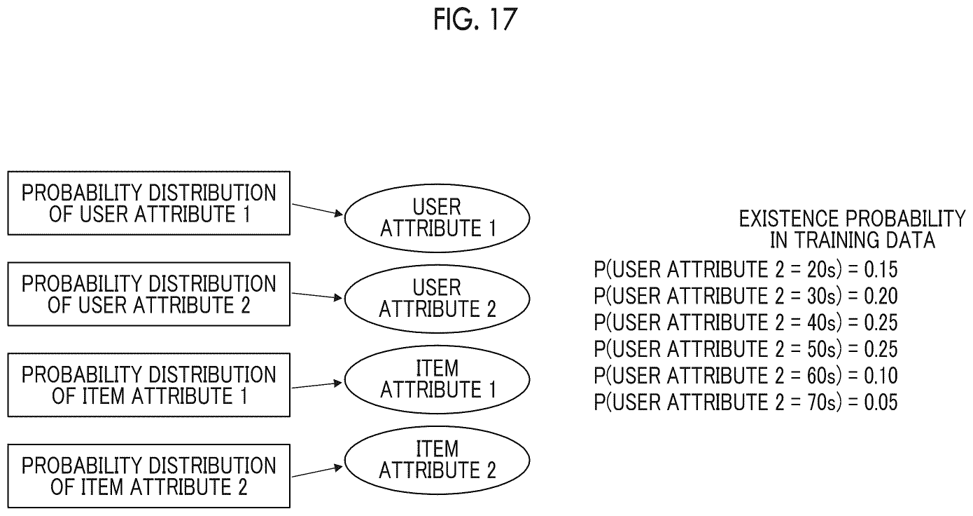

FIG. 17 shows an example of the probability P(X) of each attribute of the explanatory variable. Here, a specific example of the probability distribution for the user attribute 2 is shown. The user attribute 2 in the training data is divided into, for example, six levels, and an existence ratio of each level in the training data can be the probability distribution of the user attribute 2. By statistically processing the training data, the existence ratio (probability distribution) of each level related to the user attribute 2 is obtained. For the probability distribution of other attributes such as the user attribute 1, the item attribute 1, and the item attribute 2, the ratio of the attribute values existing in the training data may be applied in the same manner.

### Example of Representation of Simultaneous Probability Distribution Considering Context

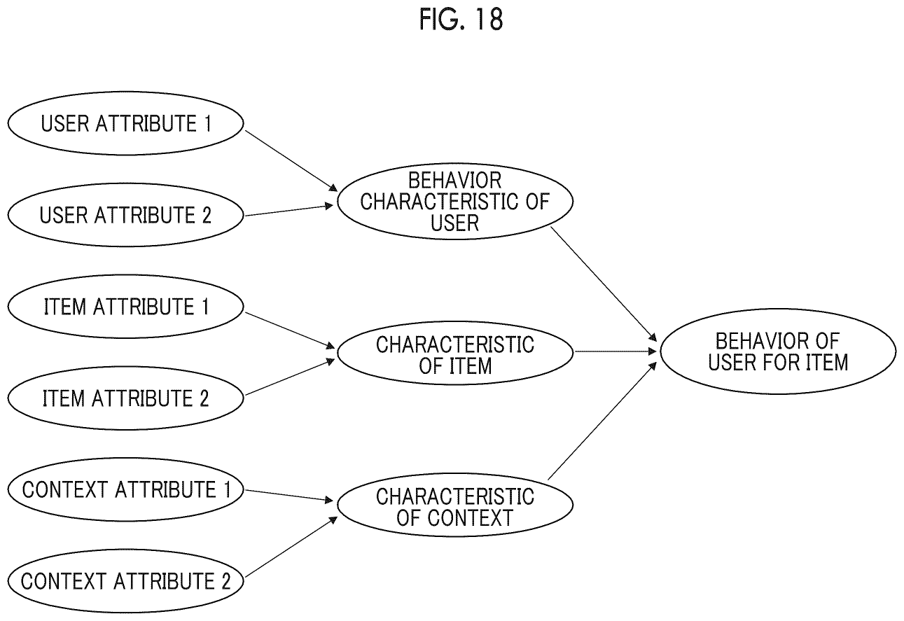

FIG. 18 is an example of a DAG of the simultaneous probability distribution including the context as the explanatory variable X. A difference between the graph shown in FIG. 18 and FIG. 13 will be described. The graph shown in FIG. 18 shows that the behavior of the user with respect to the item, which is the response variable, depends on the behavior characteristic of the user, the characteristic of the item, and the characteristic of the context (composite context), and the characteristic of the context depends on the context attribute 1 and the context attribute 2. Other configurations are the same as in FIG. 13. In a case where there is a dependency relationship between variables as shown in FIG. 18, the simultaneous probability distribution P(X,Y) can be decomposed into elements as follows.

$$P ( Y \vert X ) = P ( behavior of user with respect to item \vert behavior characteristic of user , characteristic of item , characteristic of context ) \times P ( behavior characteristic of user \vert user attribute 1 , user attribute 2 ) \times P ( characteristic of context \vert context attribute 1 , context attribute 2 )$$

In this case, for example, the simultaneous probability distribution representation unit 230 expresses the probability that the user views the item (probability of Y=1) by a sigmoid function of a sum of an inner product of the user characteristic vector and the item characteristic vector, an inner product of the item characteristic vector and the context characteristic vector, and an inner product of the context characteristic vector and the user characteristic vector.

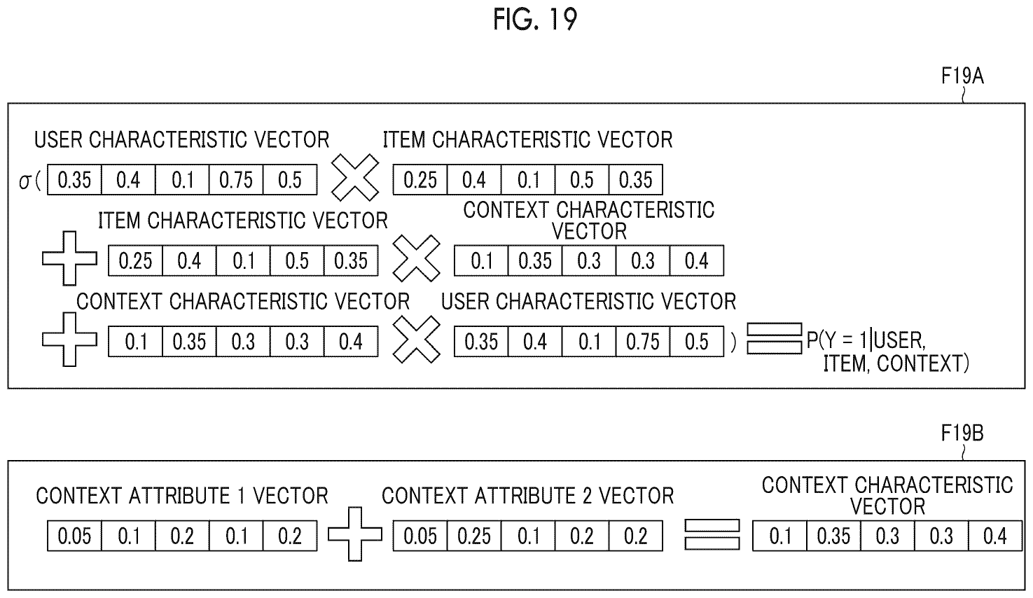

FIG. 19 shows an example of a probability representation of P(Y|X) considering the influence of the context. An expression F19A shown in the upper part of FIG. 19 is an example of an expression in which, by the matrix factorization, the user characteristic vector θu, the item characteristic vector φi, and the context characteristic vector vc are represented by 5-dimensional vectors, respectively, and a sigmoid function σ(θu·φi+φi·vc+vc·θu) of the sum of the inner products of these three types of vectors is represented as the conditional probability P(Y=1|user, item, context).

The context characteristic vector vc is represented by the addition of the attribute vectors of the contexts. For example, as in an expression F19B shown in a lower part of FIG. 19, the context characteristic vector vc is represented by a sum of a context attribute 1 vector and a context attribute 2 vector.

The value of each vector of the user attribute 1 vector, the user attribute 2 vector, the item attribute 1 vector, the item attribute 2 vector, the context attribute vector 1, and the context attribute 2 vector is determined by learning from a dataset (training data) of a user behavior history in a given domain.

In the dependency relationship between the variables shown in FIG. 18, the parameters to be learned from the dataset are the following parameters in addition to the parameters described using FIGS. 13 to 16.
Context characteristic vector: vc
Context attribute 1 vector: Vk_c\hat{ }1
Context attribute 2 vector: Vk_c\hat{ }2

However, these parameters satisfy the following relationships.

$$\cdot vc = Vk\_c \hat{} 1 + Vk\_c \hat{} 2$$

In this case, as the loss function in the learning, for example, a log loss shown in Expression (3) is used instead of Expression (1).

$$L = - [ Y log σ ( θ u \cdot φ i + φ i \cdot vc + vc \cdot θ u ) + ( 1 - Y ) log \{ 1 - σ ( θ u \cdot φ i + φ i \cdot vc + vc \cdot θ u ) \} ] \qquad ( 3 )$$

### [Calibration of Prediction Model]

Depending on the design of the model, a prediction score output from the model may not necessarily correspond to the numerical value as the behavior probability. In this case, it is preferable to convert the output score of the model such that the prediction score output by the model of P(Y|X) is close to the probability of the actual behavior Y=1 (behavior present). Such conversion is referred to as calibration.

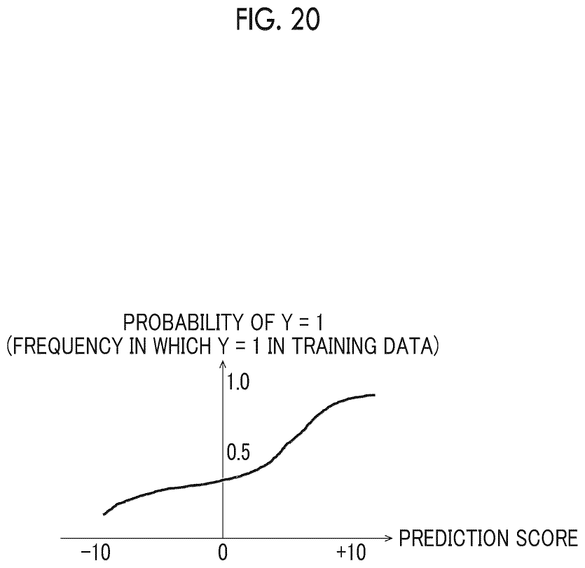

FIG. 20 is a graph showing an example of calibration. The horizontal axis in FIG. 20 represents the prediction score output from the model, and the vertical axis represents the probability of Y=1. FIG. 20 shows an example of a case where the prediction score output by the model can take a value in a range of “−10” to “+10”.

In order to perform calibration, the processor 102 examines a relationship between the prediction score and the probability of Y=1. The probability of Y=1 here corresponds to the frequency of Y=1 in the training data. For example, it is assumed that it is found that the prediction score and the probability of Y=I have a relationship as shown in FIG. 20. In FIG. 20, the probability of Y=1 is “0.2” in a case where the prediction score is “−10”, the probability of Y=1 is “0.4” in a case where the prediction score is “0”, and the probability of Y=1 is “0.9” in a case where the prediction score is “+10”. In this case, by the calibration, the score value “−10” is converted to “0.2”, the score value “0” is converted to “0.4”, and the score value “+10” is converted to “0.9”. By applying such calibration, the output score of the model can be converted into a probability representation even in a case where the output score of the model is not a value corresponding to the probability, and thus the degree of freedom of the model selection is expanded.

### [Regarding Generation of Data]

In a case in which the representation of the simultaneous probability distribution P(X,Y) is determined, the explanatory variable X and the response variable Y can be stochastically sampled from the simultaneous probability distribution P(X,Y). For example, the data generation unit 234 can generate data of the explanatory variable X and the response variable Y by the following procedure. Here, the simultaneous probability distribution P(X, Y) represented by the DAG shown in FIG. 13 will be described as an example.
[Procedure 1] The user attribute and the item attribute are sampled from P(X). For example, in a case where P (user attribute 2=40 years old)=0.25, the data of the user attribute 2 can be generated by determining the generation probability of the data of the user attribute 2 such that the user attribute 2 is 40 years old with a probability of 25%. For other attribute data as well, data can be generated according to each probability distribution.
[Procedure 2] A user characteristic vector and an item characteristic vector are generated based on the vector representations corresponding to the sampled user attributes and item attributes (refer to FIG. 14).
[Procedure 3] P(Y|X) is obtained from the logistic function of the inner product of the user characteristic vector and the item characteristic vector. In FIG. 14, an example in which a sigmoid function is used as the logistic function is shown.
[Procedure 4] Y is sampled based on P(Y|X). For example, in a case where P(Y|X)=0.2 is satisfied for X sampled in the procedure 1, Y=1, that is, a positive example is determined with a probability of 20%.

However, in a case where the data of X and Y is generated from P(X, Y) that is learned from the original dataset, the data of the same domain as the original dataset is generated. In the present embodiment, in order to generate data of different domains, the simultaneous probability distribution modification unit 232 modifies P(X,Y) before the data generation, and the data generation unit 234 generates data on the basis of the modified simultaneous probability distribution Pm(X,Y).

### Example 1 of Modification Method for Simultaneous Probability Distribution

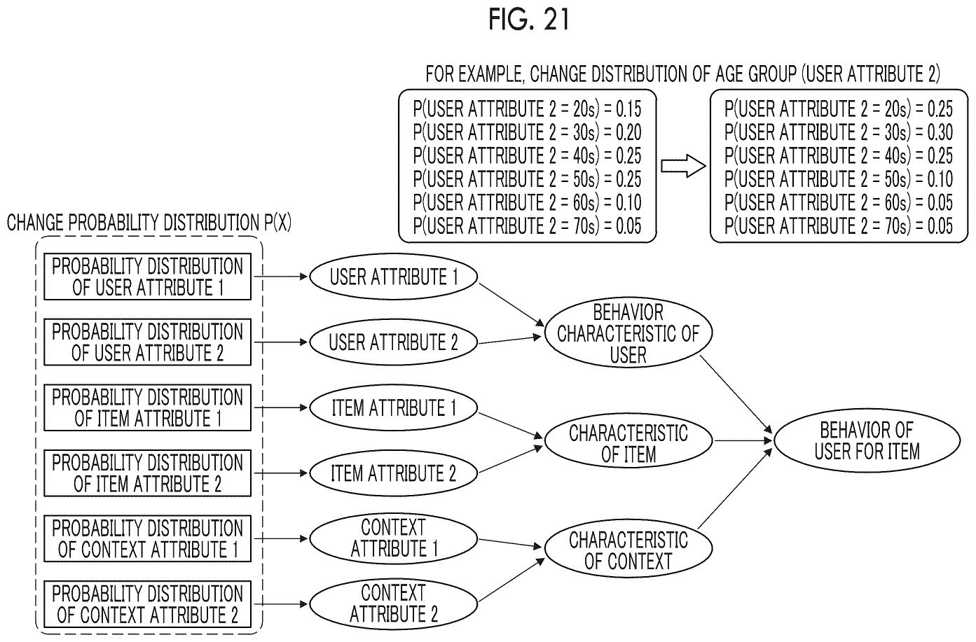

FIG. 21 is an explanatory diagram showing Example 1 of a modification method the simultaneous probability distribution. FIG. 21 shows an example in which the simultaneous probability distribution P(X,Y) is modified by changing the probability distribution P(X) of the explanatory variable X. The simultaneous probability distribution P(X, Y) can be modified by modifying at least one probability distribution of the probability distribution of the user attribute 1, the probability distribution of the user attribute 2, the probability distribution of the item attribute 1, the probability distribution of the item attribute 2, the probability distribution of the context attribute 1, or the probability distribution of the context attribute 2.

FIG. 21 shows a specific example of an aspect in which the distribution of the user attribute 2 (age group) is changed. It is assumed that the probability of each age group of the user attribute 2 in the original dataset is P (user attribute 2=20s)=0.15, P (user attribute 2=30s)=0.20, P (user attribute 2=40s)=0.25, P (user attribute 2=50s)=0.25, P (user attribute 2=60s)=0.10, and P (user attribute 2=70s)=0.05. The probability of each age group is grasped by statistically processing the original dataset. Regarding the probability of each age group of the user attribute 2, for example, the simultaneous probability distribution modification unit 232 modifies the distribution such that P (user attribute 2=20s)=0.25, P (user attribute 2=30s)=0.30, P (user attribute 2=40s)=0.25, P (user attribute 2=50s)=0.10, P (user attribute 2=60s)=0.05, and P (user attribute 2=70s)=0.05. That is, the simultaneous probability distribution modification unit 232 sets the generation probability in a case of generating the data of the user attribute 2 to the changed probability.

In this way, for example, there is an aspect in which the distribution regarding user attributes, such as the predominant age groups of users or the predominant occupations of users, can be varied. Changing the distribution of the age group means that the generation probability distribution of the data of the user attribute 2 is modified, and is an example of “changing the generation probability distribution” in the present disclosure.

### Example 2 of Modification Method for Simultaneous Probability Distribution

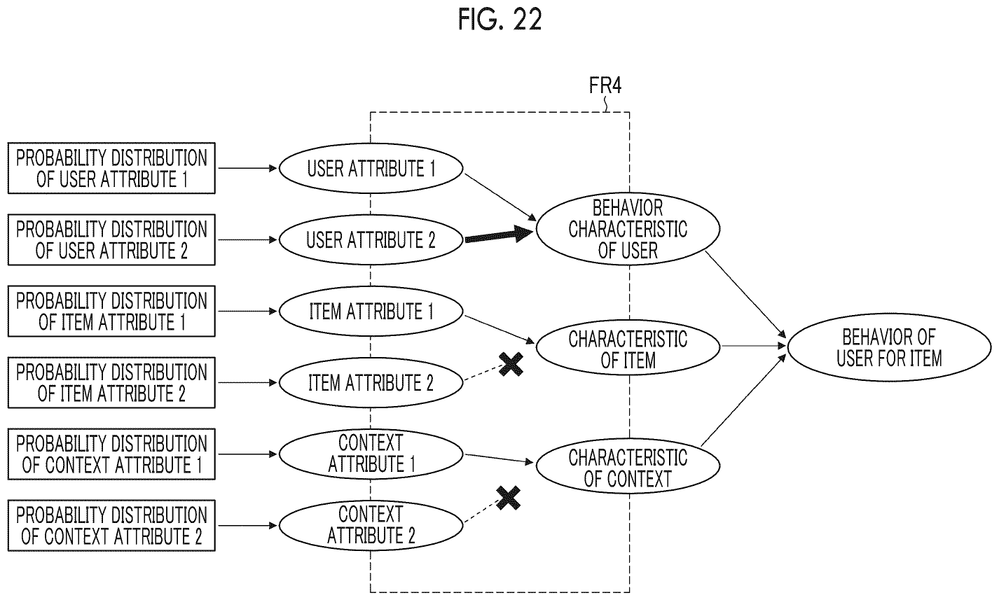

FIG. 22 is an explanatory diagram showing Example 2 of a modification method of the simultaneous probability distribution. FIG. 22 shows an example of modifying the conditional probability distribution P(Y|X). By changing the strength of the dependency relationship in the frame FR4 indicated by the broken line in the figure, P(Y|X) can be changed. In FIG. 22, an example in which the influence of the user attribute 2 on the behavior characteristic of the user is stronger in the relationship among the user attribute 1, the user attribute 2, and the behavior characteristic of the user is shown.

In addition, FIG. 22 shows an example in which the influences of the item attribute 2 and the context attribute 2 are eliminated. That is, in FIG. 22, an example in which the dependency of the item attribute 2 is eliminated (erased) by the characteristic of the item in the relationship among the item attribute 1, the item attribute 2, and the characteristic of the item is shown, and an example in which the dependency of the item attribute 2 is eliminated by the characteristic of the item in the relationship among the context attribute 1, the context attribute 2, and the characteristic of the context is shown. The elimination of the dependence is an extreme example in a case where a degree of influence is weakened.

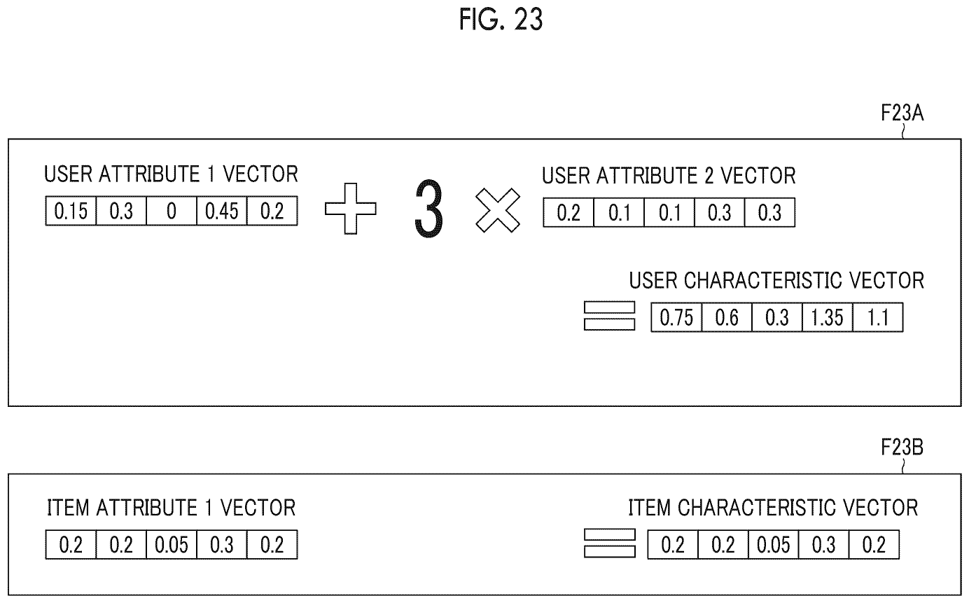

FIG. 23 shows an example of the modified user characteristic vector and the item attribute vector. Expression F23A shown in the upper part of FIG. 23 is an example in a case where the degree of influence of the user attribute 2 is increased, and shows an example in which the user attribute 2 vector is tripled and added to the user attribute 1 vector in a case where the user attribute 1 vector and the user attribute 2 vector are combined to obtain the user characteristic vector. The coefficient (here, 3) that is multiplied by the user attribute 2 vector is a value indicating the degree of influence. An appropriate coefficient indicating the degree of influence may be multiplied by the user attribute 1 vector.

Expression F23B shown in a lower part of FIG. 23 is an example in a case where the influence of the item attribute 2 is eliminated, and shows an example in which the item attribute 1 vector is directly used as the item characteristic vector without adding the item attribute 2 vector to the item attribute 1 vector. Although not shown in FIG. 23, even in a case where the influence of the context attribute 2 is eliminated, the context attribute 1 vector may be used as it is as the context characteristic vector as in Expression F23B.

### Example 3 of Modification Method for Simultaneous Probability Distribution

As a modification method of the simultaneous probability distribution, for example, in a case where there is an internal rule such as “the AA document is confirmed within p days”, there may be also a way to reflect the change of this rule. The internal rule may be, for example, an in-company rule or may be an in-hospital rule. It is considered that a browsing behavior is changed (affected) by such a rule. Examples of the change in the in-house rule include a change in a condition for opening a conference. In addition, an example of the change in the rule related to a purchase behavior on the EC site is a change in a tax system such as “the tax rates for food products and other products are each changed to A %”.

### Entire Flow of Information Processing Method According to Embodiment

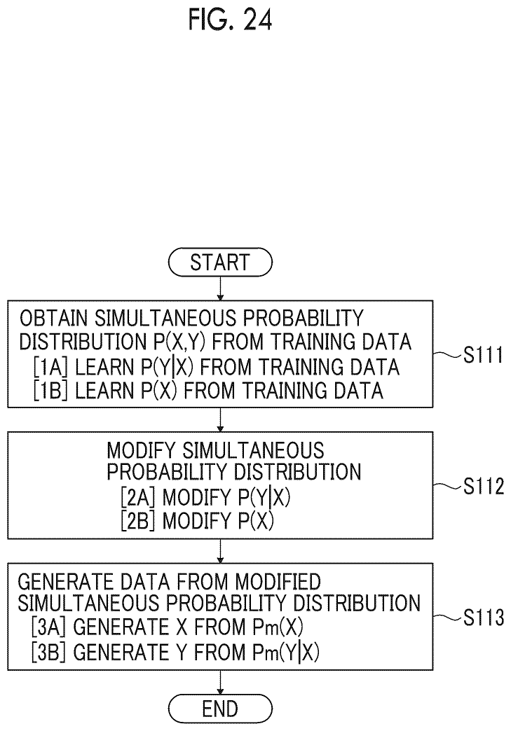

FIG. 24 is a flowchart showing a basic procedure of a data generation method using the information processing apparatus 100 according to the embodiment.

In step S111, the processor 102 determines the simultaneous probability distribution P(X,Y) from the training data. The training data here is, for example, data of the behavior history actually collected in a facility such as a certain company or a hospital, and is data of the original dataset.

The step of obtaining the simultaneous probability distribution P(X,Y) includes the following two contents [1A] and [1B]. That is, the processing of obtaining the simultaneous probability distribution P(X,Y) includes learning P(Y|X) from the training data (1A) and learning P(X) from the training data (1B). It is necessary to learn both P(Y|X) and P(X), but the order of these learning is not a problem.

Then, in step S112, the processor 102 modifies the simultaneous probability distribution P(X,Y) acquired in step S111. There are the following two aspects [2A] and [2B] in which P(X,Y) is modified. That is, there is an aspect (2A) in which P(Y|X) is modified and an aspect (2B) in which P(X) is modified. Either one of P(Y|X) or P(X) may be modified, or both may be modified.

Then, in step S113, the processor 102 generates data from the modified simultaneous probability distribution in step S111. In a case where the modified simultaneous probability distribution is defined as Pm(X,Y)=Pm(X)×Pm(Y|X), step S113 includes the following two processes [3A] and [3B]. That is, step S113 includes a process (3A) of generating X from Pm(X) and a process (3B) of generating Y from Pm(Y|X). The processor 102 generates X from Pm(X), and then generates Y from Pm(Y|X) using X.

After step S113, the processor 102 ends the flowchart of FIG. 24.

### [Method of Generating Plurality of Domain Data]

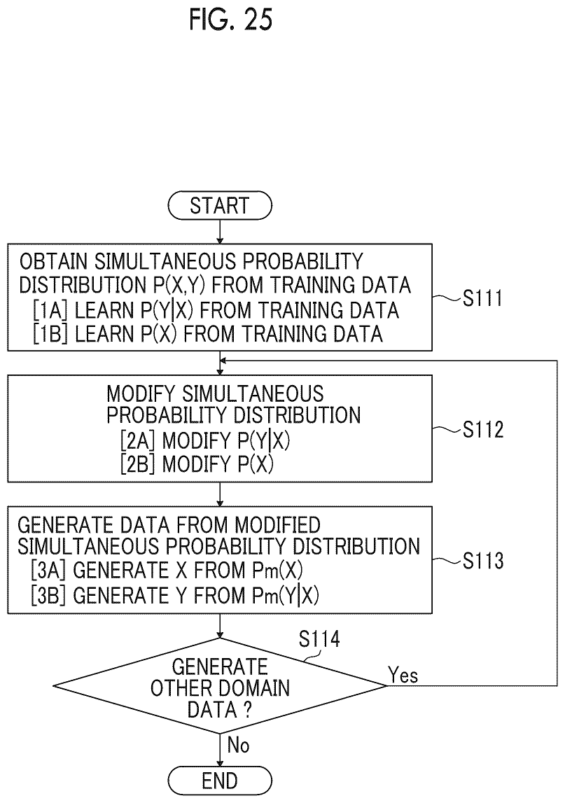

FIG. 25 is a flowchart showing a procedure of a method by which the information processing apparatus 100 according to the embodiment generates data of a plurality of domains. In FIG. 25, the same step numbers are assigned to the steps common to those in FIG. 24, and redundant description will be omitted. The same applies to other drawings.

One set of domain data is obtained by a combination of the modification in step S112 and the data generation in step S113. Therefore, in a case where the modification method is changed and steps S112 and S113 are repeated a plurality of times, a plurality of pieces of domain data can be generated.

That is, after step S113, in step S114, the processor 102 determines whether or not to generate other domain data. In a case where the determination result in step S114 is a Yes determination, the processor 102 returns to step S112 and performs modification different from the modification performed in the previous time. By executing step S112 and step S113 in this way, different domain data is generated.

In a case where the determination result in step S114 is a No determination, the processor 102 ends the flowchart in FIG. 25.

### Usage Example 1 of Generated Data: Flow in Case of being Used for Domain Generalization Learning

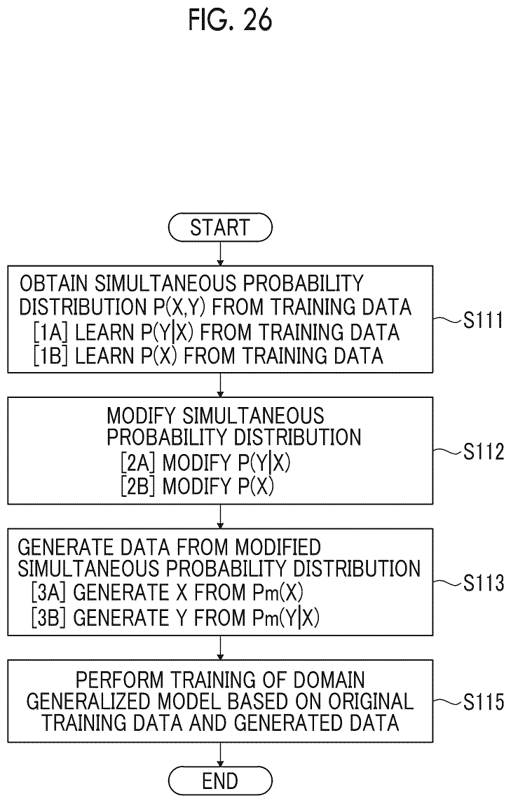

FIG. 26 is a flowchart showing a procedure in a case where the data generated by the information processing apparatus 100 according to the embodiment is used for the domain generalization learning. In FIG. 26, steps S111 to S113 are the same as those in FIG. 24. A flowchart shown in FIG. 26 includes Step S115 added after Step S113 in FIG. 24.

In step S115, the processor 102 or another processor performs the learning to obtain the domain generalization model based on the original training data and the generated data. Step S115 may be executed by a processor different from the processor 102 that generates the data in step S111 to step S113. That is, the information processing apparatus 100 that generates the data and the machine learning apparatus that trains the model 14 using the generated data as training data may be different devices or may be the same device. In addition, as described with reference to FIG. 25, Step S115 may be executed after the data of the plurality of domains is generated.

The processing of generating the data (step S111 to step S113) and the processing of performing the learning using the generated data (step S115) may be performed at separate timings or may be continuously performed. For example, one or more, preferably a plurality of different domains of data may be generated in advance in step S111 to step S113, data to be used for learning may be prepared, and then the model 14 may be trained using data of a plurality of domains including the original training data (original dataset). In addition, for example, in a case of training the model 14, the data may be generated by an on-the-fly method, and the training may be executed by inputting the generated data to the model 14.

After step S115, the processor 102 or another processor ends the flowchart in FIG. 26.

### Usage Example 2 of Generated Data: Flow in Case of being Used for Evaluation of Domain Generalization

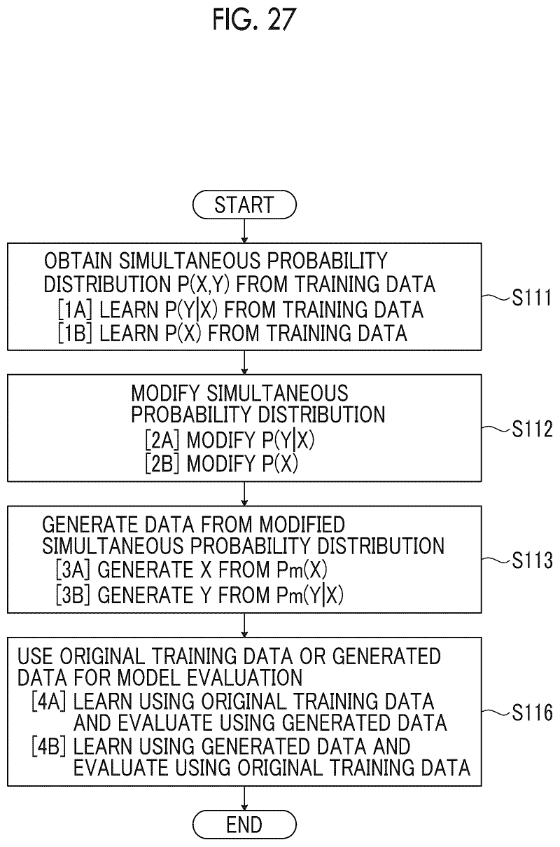

FIG. 27 is a flowchart showing a procedure in a case where the data generated by the information processing apparatus 100 according to the embodiment is used for evaluation of the domain generalization. In FIG. 27, steps S111 to S113 are the same as those in FIG. 24. In FIG. 27, a step S116 is added after the step S113.

In step S116, the processor 102 or another processor uses the original training data or the generated data for the model evaluation. Step S116 may have the following two aspects [4A] and [4B]. That is, there is an aspect (4A) in which the model 14 is trained using the original training data and the model 14 is evaluated using the generated data, and an aspect (4B) in which the model 14 is trained using the generated data and the model 14 is evaluated using the original training data. The processor 102 or another processor may perform either [4A] or [4B]. The processor 102 or another processor may perform both [4A] and [4B] to take the average of the evaluation values.

After step S116, the processor 102 or another processor ends the flowchart in FIG. 27.

### Usage Example 3 of Generated Data: In Case of being Used for Both Learning and Evaluation

In a case where the data generated by the information processing apparatus 100 is used for both the learning and the evaluation of the model 14, for example, an aspect in which at least three different domains of data including original training data (data of the first domain), first pseudo domain data (data of the second domain) generated by the information processing apparatus 100, and second pseudo domain data (data of the third domain) are prepared, the domain generalization model 14 is trained using two domain data among the prepared domain data, and the model 14 is evaluated using the remaining one domain data can also be used.

### Usage Example 4 of Generated Data

The data indicating the behavior history of the user of the pseudo domain generated by the information processing apparatus 100 may be used for, for example, the following applications, in addition to being used for learning and/or evaluation for constructing the suggestion model.

### Another Usage Example 1: Utilization for Demand Prediction

For example, in a case of data related to a purchase behavior of a product (item), a purchase prediction for all users is made, and the prediction results are added for each item, whereby a predicted value of the total purchase number is obtained. The predicted value of the total number of purchases corresponds to a value indicating the demand. In a case where the demand is known, it is possible to take measures in advance, such as purchasing the product based on the predicted value.

### Another Use Example 2: Utilization for Suppressing User from Leaving

In a case where the total of all items is calculated for each user from the data of the behavior history of the user, a value indicating the activity level of the user is obtained. For example, in a case where the activity level is decreased, it is considered that the concern that the user will leave is increased. As a measure for suppressing the user from leaving, there is also a usage aspect such as predicting the behavior of the user from data.

[Regarding Program that Operates Computer]

It is possible to record a program causing a computer to implement some or all of the processing functions of the information processing apparatus 100, in a computer-readable medium that is a non-temporary information storage medium such as an optical disk, a magnetic disk, a semiconductor memory, or other tangible object, and provide the program through this information storage medium.

Also, instead of the aspect in which the program is stored in such a non-transitory computer-readable medium such as tangible object and provided, a program signal can be provided as a download service by using an electric telecommunication line, such as the Internet.

Further, some or all of the processing functions in the information processing apparatus 100 may be implemented by cloud computing or may be provided as a software as a service (SaaS).

### [Regarding Hardware Configuration of Each Processing Unit]

Hardware structures of processing units that execute various kinds of processing, such as the data acquisition unit 220, the simultaneous probability distribution representation unit 230, the simultaneous probability distribution modification unit 232, the data generation unit 234, the explanatory variable generation unit 235, and the response variable generation unit 236 in the information processing apparatus 100 are, for example, various processors as shown below.

Various processors include a CPU, which is a general-purpose processor that executes a program and functions as various processing units, GPU, a programmable logic device (PLD), which is a processor whose circuit configuration is able to be changed after manufacturing such as a field programmable gate array (FPGA), a dedicated electric circuit, which is a processor having a circuit configuration specially designed to execute specific processing such as an application specific integrated circuit (ASIC), and the like.

One processing unit may be configured by one of these various processors or may be configured by two or more processors of the same type or different types. For example, one processing unit may be configured with a plurality of FPGAs, a combination of CPU and FPGA, or a combination of CPU and GPU. Further, a plurality of processing units may be composed of one processor. As an example of configuring a plurality of processing units with one processor, first, as represented by a computer such as a client or a server, there is a form in which one processor is configured by a combination of one or more CPUs and software, and this processor functions as a plurality of processing units. Second, as represented by a system-on-chip (SoC) or the like, there is a form in which a processor, which implements the functions of the entire system including a plurality of processing units with one integrated circuit (IC) chip, is used. As described above, various processing units are configured by one or more of the various processors described above, as the hardware structure.

Further, the hardware structure of these various processors is, more specifically, an electric circuit (circuitry) in which circuit elements, such as semiconductor elements, are combined.

### Advantages of Embodiment

With the information processing apparatus 100 according to the embodiment, it is possible to generate data indicating the behavior history of the user in the domain different from the original dataset based on the modified simultaneous probability distribution Pm(X,Y) obtained by modifying the simultaneous probability distribution P(X,Y) obtained from the given original dataset. By using the generated data as training data, it is possible to train the domain generalization model 14. In addition, by using the generated data as evaluation data, it is possible to evaluate the domain generalization.

According to the present embodiment, even in a case where it is difficult to prepare the data of the plurality of domains in reality, it is possible to provide a suggestion system for domain generalization capable of generating the pseudo data of the different domain from the given one domain data. By using the data generated by the present embodiment, it is possible to contribute to the improvement of the performance of the suggestion system and the realization of the performance evaluation with high reliability.

### Other Application Examples

In the embodiment described above, the user behavior history related to the document browsing has been described as an example, but the application range of the present disclosure is not limited to the document browsing, and the data related to the user's behavior for various items can be applied regardless of the use, such as the viewing of a medical image or the like, the purchase of a product, or the viewing of a video or the like.

### [Others]

The present disclosure is not limited to the above-described embodiment, and various modifications can be made without departing from the spirit of the idea of the present disclosed technology.

### EXPLANATION OF REFERENCES

10: suggestion system
12: prediction model
14: model
100: information processing apparatus
102: processor
104: computer-readable medium
106: communication interface
108: input/output interface
110: bus
112: memory
114: storage
130: simultaneous probability distribution representation program
132: simultaneous probability distribution modification program
134: data generation program
140: original dataset storage unit
142: simultaneous probability distribution representation storage unit
144: generated data storage unit
152: input device
154: display device
220: data acquisition unit
230: simultaneous probability distribution representation unit
232: simultaneous probability distribution modification unit
234: data generation unit
235: explanatory variable generation unit
236: response variable generation unit
240: data storing unit
F14A: expression
F14B: expression
F14C: expression
F19A: expression
F19B: expression
F23A: expression
F23B: expression
FR1: frame
FR2: frame
FR3: frame
FR4: frame
IT1: item
IT2: item
IT3: item
S111 to S114: step of information processing method
S115: step of training domain generalized model
S116: step of evaluating model
Xmj: explanatory variable
Ymj: response variable

What is claimed is:

1. An information processing method executed by one or more processors, the information processing method comprising:
causing the one or more processors to
represent a simultaneous probability distribution between a response variable and an explanatory variable, with a behavior for an item of a user as the response variable, for a dataset including a behavior history with respect to a plurality of the items of a plurality of the users,
modify a part of the simultaneous probability distribution, and
generate data based on the modified simultaneous probability distribution.

2. The information processing method according to claim 1,
wherein the modification includes changing a generation probability distribution of at least a part of the explanatory variables.

3. The information processing method according to claim 1,
wherein the modification includes changing a degree of dependence between variables of the explanatory variables.

4. The information processing method according to claim 1,
wherein the modification includes reflecting a change in a rule that affects the simultaneous probability distribution.

5. The information processing method according to claim 1, further comprising:
causing the one or more processors configured to generate a model that represents the simultaneous probability distribution by performing machine learning using the dataset.

6. The information processing method according to claim 1,
wherein the explanatory variable includes an attribute of the user and an attribute of the item.

7. The information processing method according to claim 6,
wherein the explanatory variable further includes a context.

8. The information processing method according to claim 6,
wherein the representation of the simultaneous probability distribution includes a representation of a conditional probability distribution represented by a function using an inner product between a user characteristic vector represented by using a vector indicating the attribute of the user and an item characteristic vector represented by using a vector indicating the attribute of the item.

9. The information processing method according to claim 7,
wherein the representation of the simultaneous probability distribution includes a representation of a conditional probability distribution represented by a function using a sum of the inner product between the user characteristic vector represented by using the vector indicating the attribute of the user and the item characteristic vector represented by using the vector indicating the attribute of the item, an inner product between the item characteristic vector and a context characteristic vector represented by using a vector indicating an attribute of the context, and an inner product between the context characteristic vector and the user characteristic vector.

10. The information processing method according to claim 8,
wherein the function is a logistic function.

11. An information processing apparatus comprising:
one or more processors; and
one or more memories in which a command executed by the one or more processors is stored,
wherein the one or more processors are configured to
represent a simultaneous probability distribution between a response variable and an explanatory variable, with a behavior for an item of a user as the response variable, for a dataset including a behavior history with respect to a plurality of the items of a plurality of the users,
modify a part of the simultaneous probability distribution, and
generate data based on the modified simultaneous probability distribution.

12. A non-transitory, computer-readable tangible recording medium on which a program for causing, when read by a computer, the computer to realize functions comprising:
representing a simultaneous probability distribution between a response variable and an explanatory variable, with a behavior for an item of a user as the response variable, for a dataset including a behavior history with respect to a plurality of the items of a plurality of the users;
modifying a part of the simultaneous probability distribution; and
generating data based on the modified simultaneous probability distribution.
